(19) United States
(12) Patent Application Publication
(10) Pub. No.: US 2015/0317070 A1
(43) Pub. Date: Nov. 5, 2015

(54) MOBILE HANDHELD INSTRUMENTS AND METHODS

(71) Applicant: IKEGPS Group Limited, Mount Cook (NZ)

(72) Inventors: Leon Mathieu LAMMERS VAN TOORENBURG, Belmont (NZ); Jeremy James GOLD, Karori (NZ)

(21) Appl. No.: 14/683,224

(22) Filed: Apr. 10, 2015

Related U.S. Application Data
(60) Provisional application No. 61/978,350, filed on Apr. 11, 2014.
(60) Provisional application No. 62/095,245, filed on Dec. 22, 2014.

(51) Int. Cl. G06F 3/0484; G06F 3/0482; G06F 3/0488; G06F 3/0486

(52) U.S. Cl. CPC G06F 3/04845; G06F 3/04842; G06F 3/0486; G06F 3/0482; G06F 3/0488

(57) ABSTRACT

A mobile handheld instrument having a camera, display, user interface, spatial sensors and inertial measurement unit. Upon user selection of an image region within a captured image a processor may determine an orientation of a surface within the image and the region is forced into alignment with the determined orientation of the surface. The processor may also overlay a plurality of markers on a displayed camera feed, each marker being overlaid at a target position for which spatial sensors have already captured data. A user may also select target categories and captured data sets obtained by spatial sensors and associated with the selected target categories. Measurements captured for target points may be overlaid on the displayed camera feed. The determined measurement data may be updated based on a user instruction to alter the set of target points. Spatial data sets may be corrected for detected movement of the instrument and to stitch the captured images to form an image file having a larger coverage than the camera field of view. The spatial data sets may be corrected for the detected movement of the instrument and to determine one or more of a distance between two target points or relative positions of two target points. A back-facing camera directed towards a user may be used to detect movement of the instrument.

This application claims benefit of U.S. Provisional Ser. No. 61/978,350, filed 11 Apr. 2014 and U.S. Provisional Ser. No. 62/095,245, filed 22 Dec. 2014 and which applications are incorporated herein by reference. To the extent appropriate, a claim of priority is made to each of the above disclosed applications.

### FIELD OF THE INVENTION

The invention relates to mobile instruments for gathering data.

### BACKGROUND TO THE INVENTION

Various instruments are available for gathering image and/or spatial data. Two such instruments are described in the Applicant's U.S. Pat. No. 7,647,197 and PCT application PCT/NZ2011/000257.

Reference to any prior art in this specification does not constitute an admission that such prior art forms part of the common general knowledge.

It is an object of the invention to provide an improved mobile instrument and/or associated method or at least to provide the public with a useful choice.

Each object is to be read disjunctively with the object of at least providing the public with a useful choice.

### SUMMARY OF THE INVENTION

In a first aspect the invention provides a mobile handheld instrument including:

a camera configured to capture an image;

a display configured to display the image;

a processor configured to determine an orientation of a surface within the image;

a user interface configured to receive a user selection of a region on the surface;

wherein the user selection of the region is forced into alignment with the determined orientation of the surface.

Preferably the display is configured to display the selected region overlaid on the image.

The region may be a one dimensional region. Preferably the user selection of the one dimensional region is forced into alignment with a true space horizontal or true space vertical based on the determined orientation of the surface.

Preferably the region is a two dimensional region. Preferably the user selection of the region is forced into alignment with a true space horizontal and a true space vertical based on the determined orientation of the surface.

Preferably the region is a true space rectangle. Preferably the user selection of the region consists of the user selecting a first corner of the rectangle and a second diagonally opposite corner of the rectangle. Preferably selecting the first and second corners consists of the user dragging a pointer from the first corner to the second corner.

Alternatively the region may be a true space circle. Preferably the user selection of the region consists of the user selecting first and second points defining the circle.

Preferably determining the orientation of the surface includes identifying one or more sets of parallel lines in the image and analyzing the vanishing point of each set of parallel lines.

Alternatively determining the orientation of the surface includes identifying the positions of three or more points on the surface and fitting a surface to those points.

Alternatively determining the orientation of the surface includes identifying one or more shapes on the surface and determining an orientation of the surface based on knowledge or assumptions relating to the true space properties of those shapes.

The mobile handheld instrument may be configured to receive a user copy instruction and to create a copy of the user selection in response to the user copy instruction and to display the copy of the user selection on the display.

The mobile handheld instrument may be configured to receive a user instruction to move the copy of the user selection, to move the displayed copy of the user selection, wherein the true space dimensions of the copy of the user selection are retained during movement of the copy of the user selection, with the displayed dimensions of the copy of the user selection being adjusted accordingly during movement of the copy of the user selection.

The mobile handheld instrument may be configured to detect like image regions based on comparison of image data within the user selection with image data elsewhere on the surface and to replicate the user selection at each like image region.

Preferably each replica user selection has the same true space dimensions and orientation as the user selection.

Preferably the surface is a plane.

The mobile handheld instrument may be configured to receive a user instruction to adjust the determined orientation of the surface or the forced alignment of the user selection and to adjust the determined orientation or forced alignment accordingly.

The mobile handheld instrument may be configured to determine one or more true space measurements and to display those measurements.

Preferably the display and user interface are both provided by a touch screen.

Preferably the mobile handheld instrument includes a rangefinder.

Preferably the mobile handheld instrument includes a positioning sensor.

Preferably the mobile handheld instrument includes one or more orientation sensors.

In a further aspect the invention provides a method of data collection in a mobile handheld instrument including:

a camera;

a display;

a processor; and

a user interface

the method including the steps of:

receiving a capture instruction from a user;

in response to the capture instruction, capturing an image using the camera;

displaying the captured image on the display;

the processor determining an orientation of a surface within the image;

the user interface receiving a user selection of a region on the surface;

forcing the user selection of the region into alignment with the determined orientation of the surface; and

displaying the user selection on the display.

The region may be a one dimensional region. Preferably the step of forcing the user selection of the region into alignment with the determined orientation of the surface comprises forcing the user selection into alignment with a true space horizontal or true space vertical based on the determined orientation of the surface.

Preferably the region is a two dimensional region.

Preferably the step of forcing the user selection of the region into alignment with the determined orientation of the surface comprises forcing the user selection into alignment with a true space horizontal and a true space vertical based on the determined orientation of the surface.

Preferably the region is a true space rectangle. Preferably the step of receiving a user selection of a region on the surface consists of receiving a user identification of a first corner of the rectangle and a second diagonally opposite corner of the rectangle.

Preferably the step of receiving a user selection of a region on the surface consists of receiving a user identification of a first corner of the rectangle and a second diagonally opposite corner of the rectangle by dragging a pointer from the first corner to the second corner.

Alternatively the region is a true space circle. Preferably the step of receiving a user selection of a region on the surface consists of receiving a user identification of first and second points defining the circle.

Preferably determining the orientation of the surface includes identifying one or more sets of parallel lines in the image and analyzing the vanishing point of the each set of parallel lines.

Alternatively determining the orientation of the surface includes identifying the positions of three or more points on the surface and fitting a surface to those points.

Alternatively determining the orientation of the surface includes identifying one or more shapes on the surface and determining an orientation of the surface based on knowledge or assumptions relating to the true space properties of those shapes.

Preferably the method includes:
receiving a user copy instruction,
creating a copy of the user selection in response to the user copy instruction, and
displaying the copy of the user selection on the display.

Preferably the method includes:
receiving a user instruction to move the copy of the user selection,
moving the displayed copy of the user selection while retaining the true space dimensions of the copy of the user selection during movement of the copy of the user selection and adjusting the displayed dimensions of the copy of the user selection accordingly.

Preferably the method includes:
detecting like image regions based on comparison of image data within the user selection with image data elsewhere on the surface, and
replicating the user selection at each like image region.

Preferably each replica user selection has the same true space dimensions and orientation as the user selection.

Preferably the surface is a plane.

Preferably the method includes:
receiving a user instruction to adjust the determined orientation of the surface or the forced alignment of the user selection, and
adjusting the determined orientation or forced alignment accordingly.

Preferably the method includes:
determining one or more true space measurements, and
displaying those measurements.

Preferably the display and user interface are both provided by a touch screen.

Preferably the instrument further includes a rangefinder, the method further including:
receiving a user capture instruction, and
capturing an image from the camera and a distance measurement from the rangefinder in response to that user capture instruction.

Preferably the instrument further includes a rangefinder, a positioning sensor and one or more orientation sensors, the method further including:
receiving a user capture instruction, and
capturing an image from the camera, a distance measurement from the rangefinder, a position from the positioning sensor and an orientation from the one or more orientation sensors, in response to that user capture instruction.

In a further aspect the invention provides a mobile handheld instrument including: a camera having a camera field of view and configured to provide a camera feed; one or more spatial sensors configured to capture substantially continuously a plurality of data sets, each data set being related to a target position within the camera field of view;

a display configured to display the camera feed in real time;

a processor configured to overlay a plurality of markers on the displayed camera feed, each marker being overlaid at a target position for which the one or more spatial sensors have already captured data.

Preferably the plurality of markers are displayed as a plurality of distinct marker symbols.

Preferably the plurality of markers are displayed as a continuous line or path.

Preferably the processor is configured to overlay the plurality of markers on the displayed camera feed in real time.

In another aspect the invention provides a method of data collection in a mobile handheld instrument including:

a camera;

a display;

one or more spatial sensors;

a processor; and
the method including:

capturing image data using the camera and providing the image data as a real time camera feed to the display;

displaying the camera feed in real time;

capturing substantially continuously a plurality of spatial data sets from the one or more spatial sensors, each data set being related to a target position within the camera field of view;

overlaying a plurality of markers on the displayed camera feed, each marker being overlaid at a target position for which the one or more spatial sensors have already captured data.

Preferably the plurality of markers are displayed as a plurality of distinct marker symbols.

Preferably the plurality of markers are displayed as a continuous line or path.

Preferably the plurality of markers are overlaid on the displayed camera feed in real time.

In a further aspect the invention provides a mobile handheld instrument including:

a camera having a camera field of view and configured to provide a camera feed;

a user interface configured for user selection of one of a plurality of target categories;

one or more spatial sensors configured to capture a plurality of data sets, each data set being related to a target position within the camera field of view;

a display configured to display the camera feed in real time; and

a processor configured to associate the captured data sets with the selected target categories.

Preferably the target categories include a ground category.

Preferably the target categories include one or more of: a skyline category, an edge category, a surface category, and an object category.

The mobile handheld instrument may be configured to allow user definition of one or more target categories.

Preferably the one or more spatial sensors are configured to capture substantially continuously the plurality of data sets.

Preferably the processor is configured to use the captured data sets together with the target categories associated with the captured data sets to form a three dimensional model.

Preferably the processor is configured to overlay a plurality of markers on the displayed camera feed, each marker being overlaid at a target position for which the one or more spatial sensors have already captured data, wherein each displayed marker has one or more display properties that associate that marker with one of the target categories.

Preferably the display properties include one or more of: marker symbol, colour, size, pattern and style.

In a further aspect the invention provides a method of data collection in a mobile handheld instrument including:

a camera;

a display;

one or more spatial sensors; and

a user interface;
the method including:

capturing image data using the camera and providing the image data as a real time camera feed to the display;

displaying the camera feed in real time;

capturing substantially continuously a plurality of spatial data sets from the one or more spatial sensors, each data set being related to a target position within the camera field of view;

a user selecting one of a plurality of target categories; and

associating the captured data sets with the selected target categories.

Preferably the target categories include a ground category.

Preferably the target categories include one or more of: a skyline category, an edge category, a surface category, and an object category.

The mobile handheld instrument may be configured to allow user definition of one or more target categories.

Preferably the one or more spatial sensors are configured to capture substantially continuously the plurality of data sets.

Preferably the processor is configured to use the captured data sets together with the target categories associated with the captured data sets to form a three dimensional model.

Preferably the processor is configured to overlay a plurality of markers on the displayed camera feed, each marker being overlaid at a target position for which the one or more spatial sensors have already captured data, wherein each displayed marker has one or more display properties that associate that marker with one of the target categories.

Preferably the display properties include one or more of: marker symbol, colour, size, pattern and style.

In another aspect the invention provides a mobile handheld instrument including: a camera having a camera field of view and configured to provide a camera feed; one or more spatial sensors configured to capture data related to a target point within the camera field of view;

a display configured to display the camera feed in real time;

a processor configured to overlay one or more measurements on the displayed camera feed, each measurement being calculated from the captured data for two or more target points and being overlaid in a position associated with at least one of those two or more target points.

Preferably each measurement is overlaid in a position associated with a line or area defined by the two or more target points.

In a further aspect the invention provides a mobile handheld instrument including:

a camera having a camera field of view;

one or more spatial sensors configured to capture data related to a target point within the camera field of view;

an inertial measurement unit; and

a processor;
wherein:

the instrument is configured to capture an image from the camera and a spatial data set from the one or more spatial sensors in response to each of a plurality of user capture instructions;

the inertial measurement unit is configured to detect movement of the instrument between the plurality of user capture instructions; and

the processor is configured to process the spatial data sets to correct for the detected movement of the instrument and to stitch the captured images to form an image file having a larger coverage than the camera field of view.

Preferably the instrument is further configured to automatically collect image data independent of the user capture instructions.

Preferably, if the images captured in response to user capture instructions provide an incomplete coverage of a region extending between the target points, the processor is configured to stitch the captured images and the automatically collected image data to form the image file.

Preferably the automatically collected image data includes a plurality of periodically collected image frames.

Preferably the processor is configured to determine when the detected movement of the instrument away from a position at which image data was last collected or captured, and to automatically collect image data when that detected movement exceeds the threshold.

Preferably the processor is configured to determine when the detected movement of the instrument away from a position at which image data was last automatically collected, and to automatically collect further image data when that detected movement exceeds the threshold.

Preferably the processor is configured to stitch the image data based at least partly on analysis of the image data.

Preferably the processor is configured to stitch the image data based at least partly on the detected movement of the instrument.

In another aspect the invention provides a mobile handheld instrument including:

a camera having a camera field of view;

one or more spatial sensors configured to capture data related to a target point within the camera field of view;

an inertial measurement unit; and

a processor;
wherein:

the instrument is configured to capture an image from the camera and a spatial data set from the one or more spatial sensors in response to each of a plurality of user capture instructions;

the inertial measurement unit is configured to detect movement of the instrument between the plurality of user capture instructions; and

the processor is configured to process the spatial data sets to correct for the detected movement of the instrument and to determine one or more of a distance between two target points or relative positions of two target points,

the two target points subtending an angle at the instrument greater than the camera field of view.

In a further aspect the invention provides a mobile handheld instrument including:

a camera having a camera field of view;

one or more spatial sensors;

an inertial measurement unit;

a display;

a processor; and

a user interface;
wherein:

the instrument is configured to capture a plurality of spatial data sets from the one or more spatial sensors, the plurality of spatial data sets corresponding to a set of target points, and each spatial data set being captured in response to a user capture instruction;

the inertial measurement unit is configured to detect movement of the instrument between the plurality of user capture instructions; and

the processor is configured to:
process the spatial data sets to correct for the detected movement of the instrument;
determine measurement data based on the corrected spatial data sets;
overlay the measurement data on displayed image data captured by the camera;
update the determined measurement data based on a user instruction to alter the set of target points;
overlay the updated measurement data on the displayed image data captured by the camera.

The mobile handheld instrument may be configured to display a marker overlaid on the displayed image data at each target point.

Preferably the user instruction to alter the set of target points is an instruction to do one or more of the following: delete a target point, add a target point, move a target point, change the order of the target points, define a subset of the target points.

The mobile handheld instrument may be configured to capture one or more further spatial data sets in response to one or more further user capture instructions, after alteration of the set of target points.

The mobile handheld instrument may include a rangefinder module for physical attachment to a handheld user device.

Preferably the handheld user device is a smartphone, tablet or similar device.

In another aspect the invention provides a mobile handheld instrument including:

a first camera;

an inertial measurement unit including at least a second camera; and

a processor;

wherein:

the instrument is configured to capture an image from the first camera in response to each of a plurality of user capture instructions; and

the inertial measurement unit is configured to detect movement of the instrument between the plurality of user capture instructions.

Preferably the mobile handheld instrument includes a display, wherein the second camera is a back-facing camera with its optical axis substantially perpendicular to the display such that the second camera, in use, is directed towards the user's face.

Preferably the inertial measurement unit is configured to detect changes in dimensions or scale factor in image data obtained from the second camera, and to detect movement of the instrument at least in part through these detected changes.

Preferably the mobile handheld instrument includes one or more spatial sensors, the instrument being configured to capture a spatial data set from the one or more spatial sensors in response to each of the user capture instructions.

In a further aspect the invention provides a mobile handheld instrument including:

one or more sensors configured to capture spatial and/or image data in response to each of a plurality of user capture instructions;

an inertial measurement unit including at least a back-facing camera which, in use, is directed towards the user, the inertial measurement unit being configured to detect movement of the instrument between the plurality of user capture instructions.

Preferably the mobile handheld instrument includes a display, wherein the second camera is a back-facing camera with its optical axis substantially perpendicular to the display such that the second camera, in use, is directed towards the user's face.

Preferably the inertial measurement unit is configured to detect changes in dimensions or scale factor in image data obtained from the second camera, and to detect movement of the instrument at least in part through these detected changes.

In another aspect the invention provides a mobile handheld instrument including:

one or more sensors configured to capture spatial and/or image data in response to each of a plurality of user capture instructions;

an inertial measurement unit configured to detect movement of the instrument between the plurality of user capture instructions, the detection of movement being based at least in part on expected movements of the user's body.

Preferably the detection of movement is based at least in part on a restriction of possible movements to a surface model that is based on expected movements of the user's body.

In a further aspect the invention provides a method of data collection in a mobile handheld instrument including:

a camera;

a display; and

a processor;

the method including the steps of:

displaying an image captured by the camera on the display;

the processor determining an orientation of a surface within the image;

overlaying a graphic of a virtual or real object on the displayed image; and forcing the displayed graphic into alignment with the determined orientation of the surface.

Preferably the method includes storing an image including the captured image and the overlaid, aligned graphic in response to a user capture instruction.

Preferably the method includes the processor determining a scale associated with a region within the image, the graphic being overlaid on that region, the object having associated dimensions, wherein the dimensions of the overlaid graphic correspond to the dimensions associated with the object and the scale associated with the region.

In another aspect the invention provides a method of data collection in a mobile handheld instrument including:

a camera;

a display; and

a processor;

the method including the steps of:

displaying an image captured by the camera on the display;

the processor determining a scale associated with a region within the image;

overlaying a graphic representing a virtual or real object on the region of the displayed image, the object having associated dimensions, wherein the dimensions of the overlaid graphic correspond to the dimensions associated with the object and the scale associated with the region.

Preferably the graphic represents a virtual object and the method further includes a user adjusting the dimensions of the overlaid graphic, and the processor determining adjusted dimensions associated with the object based on the dimensions of the overlaid graphic and the scale associated with the region.

This aspect extends to a method of manufacturing an object, including: determining dimensions associated with the object by the method set out above and manufacturing the object according to those dimensions.

### BRIEF DESCRIPTION OF THE DRAWINGS

The invention will now be described by way of example only, with reference to the accompanying drawings, in which:

FIG. 1 shows a mobile instrument;

FIG. 2 is a further view of the instrument of FIG. 1;

FIG. 3 is a schematic diagram showing internal features of the instrument of FIG. 1;

FIG. 4 shows a further mobile instrument;

FIG. 5 is a schematic diagram showing internal features of the instrument of FIG. 4;

FIG. 6 shows a typical view displayed on the instrument;

FIG. 7 is a flow chart showing a capture process;

FIG. 8 shows a user selection overlaid on the display;

FIG. 9 illustrates replication of a user selection according to one embodiment;

FIG. 10 illustrates replication of a user selection according to a further embodiment;

FIG. 11 shows the replicated selection of FIG. 10, manually aligned with a region of interest;

FIG. 12 shows further user selections overlaid on the display;

FIG. 13 is a flow chart illustrating the display of a user selection;

FIG. 13A illustrates a pinhole camera model showing how the displayed user selection may be determined;

FIG. 14 shows an image captured in one embodiment;

FIG. 15 shows the image of FIG. 14, with detected edges and/or lines;

FIG. 16 shows the detected edges and/or lines of FIG. 15;

FIG. 17 is a flow chart illustrating determination of a surface orientation according to one embodiment;

FIGS. 18A to 18D shows a target surface, illustrating determination of the surface orientation;

FIGS. 19, 20, 21 and 22 illustrate a data capture method according to a further embodiment;

FIGS. 19A, 20A, 21A and 22A show instrument displays corresponding to

FIGS. 19, 20, 21 and 22 respectively;

FIG. 23 is a flow chart showing a data capture method according to one embodiment;

FIGS. 24 to 27A show displayed data and illustrate how the data set may be edited;

FIG. 28 shows an instrument display for a multipoint method;

FIG. 29 shows an instrument display for a further multipoint method;

FIG. 30 shows displayed data gathered by a multipoint method;

FIGS. 31 to 34B show images captured by the instrument and stitched to a larger image file;

FIGS. 35 to 38 show a user moving a handheld instrument;

FIGS. 39 and 39A show data captured by a second camera in one embodiment;

FIGS. 40 and 40A show data captured by a second camera in another embodiment;

FIGS. 41A to 41D illustrate one embodiment in which a model is fitted to an existing space; and

FIGS. 42A to 42D illustrate another embodiment in which a model is fitted to an existing space;

### DETAILED DESCRIPTION

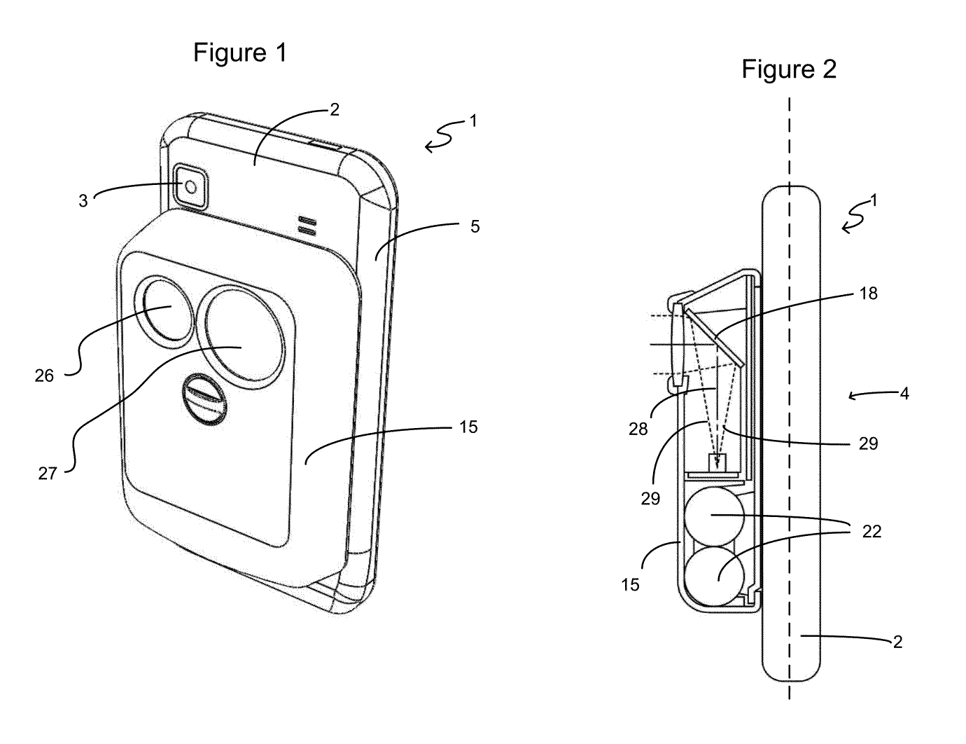

FIGS. 1 to 3 illustrate one embodiment of mobile handheld instrument. This instrument may be substantially as described in the Applicant's PCT application PCT/NZ2011/000257, the entire contents of which are hereby incorporated by reference herein.

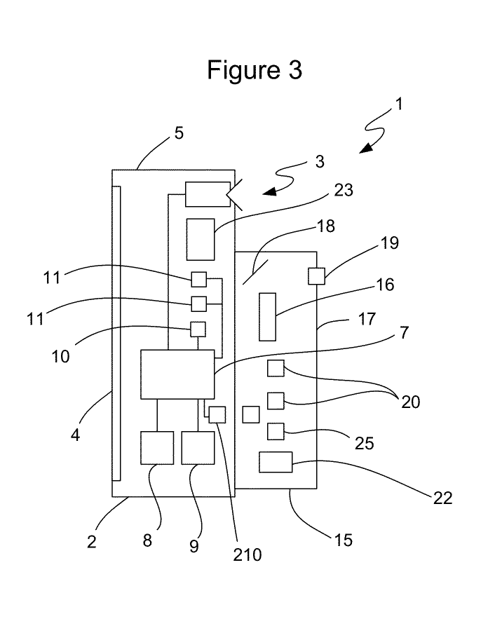

FIG. 1 shows external features of the instrument 1. FIG. 2 is a cut away view showing internal features of the rangefinder module 15, while FIG. 3 is a schematic diagram showing internal features of the instrument 1.

The instrument 1 includes a portable device 2, which may be a smartphone, tablet or similar device.

25

The portable device 2 may also be a portable GPS device. Such devices are available from suppliers such as Trimble, and may include a camera, display and GPS receiver.

The portable device is preferably a readily available item. The portable device 2 may include a camera 3 and a display 4 mounted in a housing 5. The portable device may also include a processor 7 and memory 8, and preferably includes one or more local communications modules 9, such as Bluetooth or USB communications modules. The portable device 2 may include other sensors, such as a positioning (e.g. GPS) module 10 and one or more orientation sensors 11. The orientation sensors 11 may include any suitable combination of direction-finding devices (e.g. magnetic or GPS compasses), tilt sensors and gyroscopes. The portable device preferably also includes a suitable user input arrangement, which may be a button, keypad, touchscreen, voice recognition, mouse or any other suitable input arrangement. The display and user input arrangement may both be provided by a suitable touchscreen.

The instrument 1 may also include a rangefinder module 15. The rangefinder module 15 includes a laser rangefinder 16 mounted in a housing 17. In order to achieve a compact form, the rangefinder is oriented along the housing with one or more mirrors or similar reflectors 18 redirecting the rangefinder, such that laser light is emitted and received through window 19. In general the rangefinder will be aligned along a rangefinder axis that extends from the rangefinder to a target. The reflectors 18 substantially align the rangefinder axis with the camera optical axis, with further alignment possible as discussed in PCT/NZ2011/000257.

This arrangement provides a thin or low profile rangefinder module that substantially retains the form factor of the portable device, such that the instrument 1 can be held in the same way.

The rangefinder module 15 may include other sensors 20, which may include positioning and orientation sensors. The rangefinder module preferably has a battery 22 to reduce the load on the portable device battery 23, as the rangefinder and other sensors in the rangefinder module will consume substantial energy. The rangefinder module may have a suitable port for connection of a battery charger, or the rangefinder module may draw power from a connection to the portable device.

The rangefinder module also includes a communications module 25 (such as a

Bluetooth or USB module) for communicating over a communications link with the communications module 9 of the portable device 2.

In general the rangefinder module 15 may provide any desired set of sensors to augment the sensors provided by the portable device 2. Even if the portable device includes a particular sensor, a further or more accurate sensor of the same kind may be provided in the rangefinder module.

The rangefinder module 15 may be mounted to the portable device 2 using any suitable mechanism, as discussed in PCT/NZ2011/000257.

The rangefinder module 15 has two windows 26, 27. The rangefinder beam is emitted through the first window 26 and the laser signal reflected or scattered from the target is received through the second window 27.

The rangefinder module 15 includes batteries 22, which may be standard AAA or AA batteries. The rangefinder module includes a reflector arrangement 18, which is formed by two reflectors, one for the emitted laser beam and one for the received laser beam. The rangefinder module includes a laser emitter which projects a laser beam towards the first reflector where the beam is redirected to exit the rangefinder module via the first window 26. The rangefinder module also includes a laser receiver, which measures laser light that is reflected or scattered from a target, received through the second window 27 and redirected by the second reflector towards the laser receiver.

FIG. 2 shows in dashed line the optical path 28 for the laser emitter. It also shows the optical path 29 for the laser receiver (marked by two lines 29 indicating its width). The laser paths are redirected by the reflector arrangement 18 to be substantially aligned with the optical axis of the camera 3.

The Applicant's rangefinder module is readily mounted to a standard consumer electronics device, such as a Smartphone (e.g. iPhone, Blackberry etc) or any suitable device having a camera, including portable GPS units or the like. This results in reduced cost over a dedicated instrument because many users will already have such devices, or many users will be able to justify the cost of such a device for the other functions it provides.

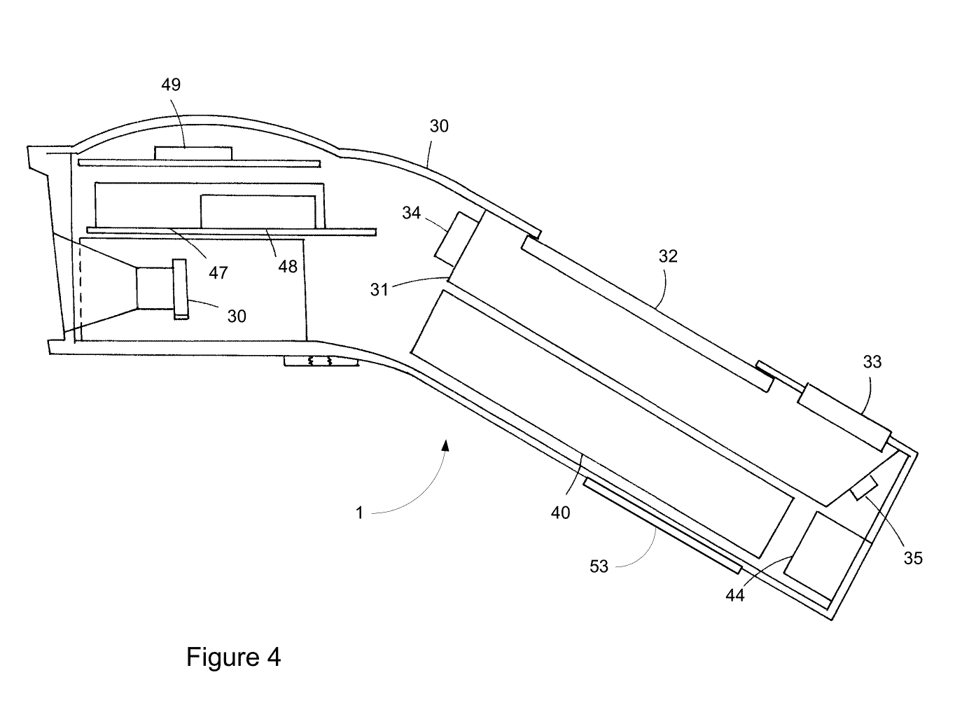

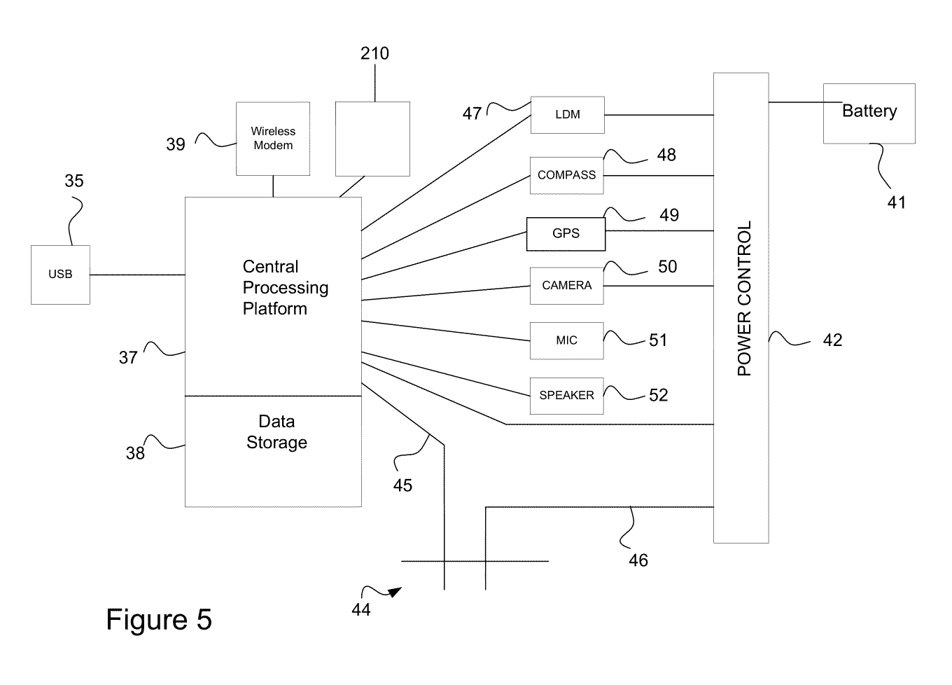

FIGS. 4 and 5 shows a further embodiment of instrument 1, similar to that of the Applicant's U.S. Pat. No. 7,647,197, the entire contents of which are hereby incorporated by reference herein.

Connections between the components are omitted in FIG. 4 for clarity but are shown in FIG. 5.

The instrument 1 has a housing 30 which contains a personal digital assistant (“PDA”), handheld computer device or similar device 31, which may have a touch-sensitive display screen 32, keypad 33, antenna 34 and USB port 35. The PDA 31 includes a central processing platform 37 (shown in FIG. 2), data storage 38, and wireless modem 39 (for driving the antenna 34). A power supply and control module 40 (shown in FIG. 4) includes a battery 41, and power control circuitry 42 (shown in FIG. 5). An external I/O port 44 includes a socket (not shown) for receiving a cable connected to an external device. The external I/O port 44 is coupled to an RS232 serial data line 45 and a power line 46 (shown in FIG. 5). This allows the recording of information from a sensor not integrated with or contained in the housing 30, for example a depth sounder, pH meter, thermometer etc. The port 44 may be replaced by an alternative physical port (such as a USB or coaxial port) or by a wireless connection (such as a Bluetooth or Wireless Lan port), allowing external sensors and devices to communicate with the PDA 31 via the antenna 34.

The instrument 1 may include a laser distance meter 47, compass 48, positioning (e.g. GPS) antenna 49, camera 50, microphone 51 and speaker 52 (not shown in FIG. 1). The instrument 1 may also include a contact sensor 53, for determining whether the device is being held in a user's hand.

The instrument of FIGS. 4 and 5 may function generally as described in U.S. Pat. No. 7,647,197.

The device of either FIGS. 1 to 3, or FIGS. 4 and 5, is capable of accurate measurements of positions of remote objects, by use of a compass, GPS and laser distance meter, as disclosed in U.S. Pat. No. 7,647,197 and PCT/NZ2011/000257.

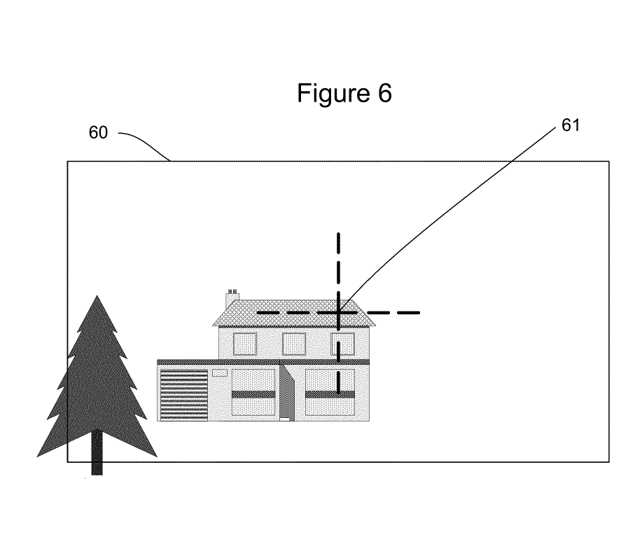

FIG. 6 shows a typical display 60 displaying an image from the camera 3, 50 to a user. The display 60 includes an overlaid marker 61, which aligned with the laser rangefinder direction. The marker 61 can be a cross-hair or any other suitable marker. Thus, the user can use the marker 61 to align the instrument 1 with a target.

When the user provides a capture instruction, the instrument will capture an image using the camera 3, 50 and a spatial data set. The spatial data set may include data obtained from the laser rangefinder 16, 47, the positioning device 10, 49 and/or orientation sensors 11, 20, 48. Substantially simultaneous data capture from all sensors can still be achieved by a suitable switching arrangement, such as described in the Applicant's U.S. Pat. No. 7,647,197.

Thus, the Applicant's invention allows intuitive and accurate aiming of the instrument 1.

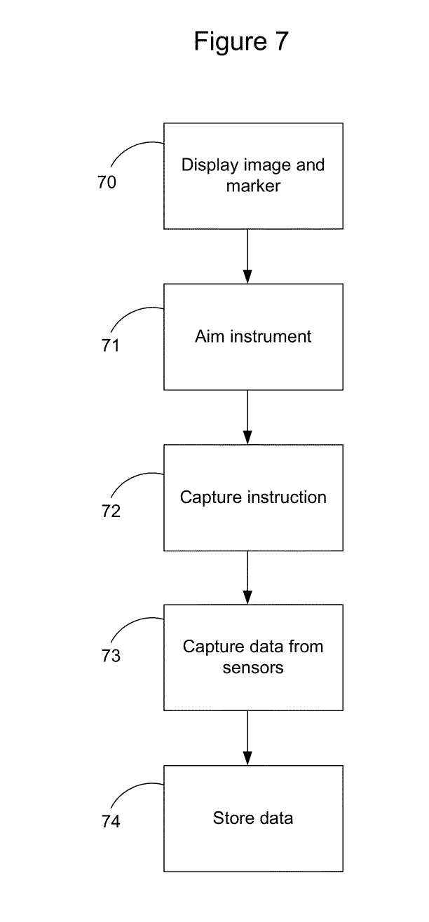

The data capture process is shown in more detail in FIG. 7. At step 70 the instrument displays an image from the camera 3, 50 on the display 4, 60, with the marker 61 overlaid as discussed above. At step 71 the user aims the instrument such that the marker 61 is aligned with a target point or position and at step 72 the user issues a capture instruction. This causes, at step 73, data to be captured from the sensors. This data may include: an image from the camera 3, 50 a position from the positioning system 10, 49, a range from the rangefinder 16, 47, and orientation from the orientation sensors 11, 20, 48. The position, range and orientation data allows the position of the target to be accurately determined. The position of the instrument is known, as is the range and direction to the target, so the target position can be calculated. At step 74, the data is stored, preferably associated as a single set of associated data, including any desired metadata, as discussed in the Applicant's U.S. Pat. No. 7,647,197.

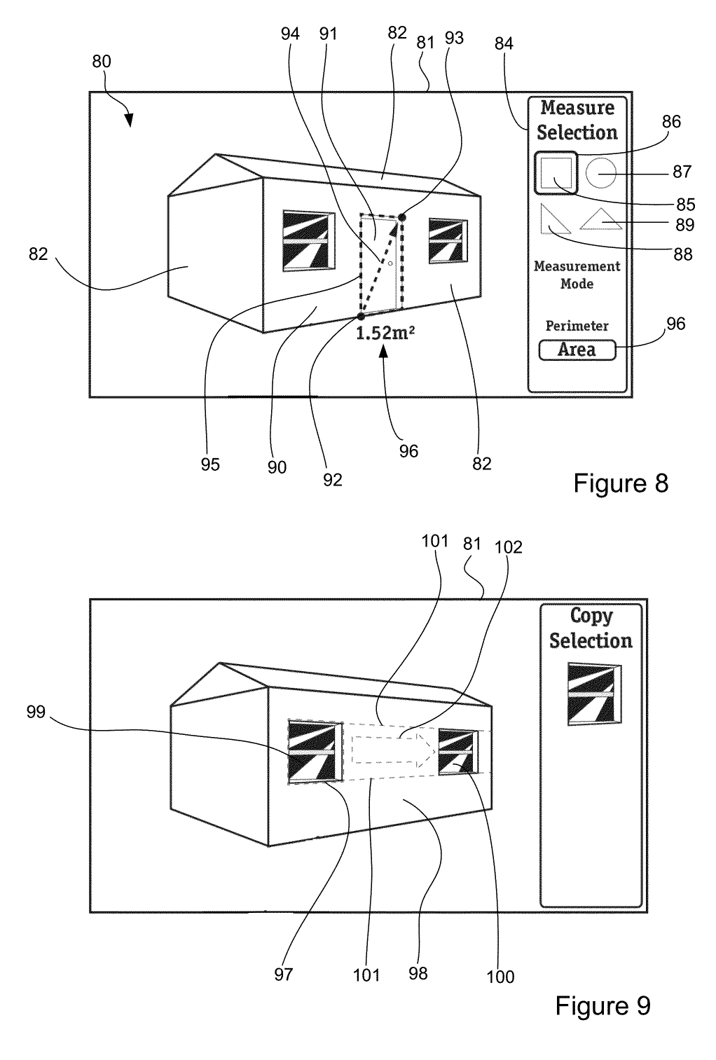

FIGS. 8 to 12 illustrate embodiments in which a user selection is displayed, overlaid on an image captured by the instrument 1.

In FIG. 8, an image 80 is displayed on the display 81 of the instrument 1. The image 80 shown is an image of a building that includes a number of rectangular surfaces 82. The surfaces 82 do not appear as rectangles, but have the usual perspective of objects in photographs due to the position of the instrument relative to the building. In this specification the term “true space” will be used to refer to the properties of objects in real three dimensional space. For example, a true space rectangle is a rectangle in true space but will appear as a skewed quadrilateral in an image, with the exact shape of that quadrilateral depending on the perspective of the image.

The Applicant's instrument allows a user to select regions on a surface within the image and to have that user selection automatically correctly aligned for the perspective of the image.

As shown in FIG. 8, a selection options window 84 may be displayed on the touchscreen 81. A user may select a type of region of interest. For example, the user may be interested in a true space rectangle. The user has therefore selected a rectangle tool 85, as indicated by selection marker 86. Other tools may also be provided, such as a circle tool 87, or triangle tools 88, 89.

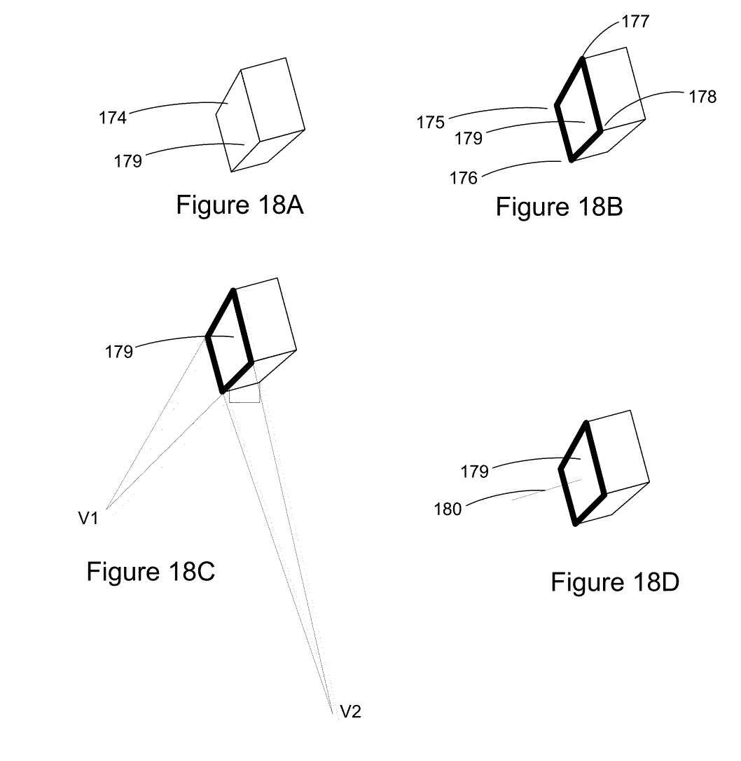

Having selected the rectangle tool 85, the user now selects a true space rectangle in the image. As a preliminary step, the user may select a surface 90 on which the region of interest lies. Alternatively, the instrument may automatically identify the surface 90 based on user selection of the region of interest. The instrument determines the orientation of the surface 90. This may be achieved in any suitable manner. For example, the orientation may be determined using a “vanishing point” method such as described below with reference to FIGS. 17 to 18D. Alternatively the orientation may be determined by the user capturing spatial data sets at different points on the surface, with the instrument then fitting a plane to those points. Alternatively, the instrument may identify one or more shapes (e.g. squares, rectangles etc) on the surface and determine the orientation of the surface based on knowledge or assumptions relating to the true space properties of those shapes.

In order to select a rectangular region of interest 91 (for example a door), the user selects diagonally opposite corners of the displayed, skewed rectangle. As indicated in FIG. 9, the user may select a first corner 92 and then select a second, diagonally opposite corner 93. This selection may be performed by separately selecting each corner (for example by tapping on the touch screen, or clicking a mouse or similar pointer device). Alternatively, the selection may be made by dragging from the first corner 92 to the second corner 93, as indicated by dashed line 94 (for example by dragging a finger on the touch screen, or dragging a mouse or similar pointer device).

As the selection is made, the instrument automatically aligns the selection based on the determined orientation of the surface 90. The selection may be indicated by a selection outline 95. Note that the skewed shape of the selection outline 95 matches the perspective of the image. In true space the selection outline defines a region of the surface 90 that is a true space rectangle.

Thus, the user selection of the region is forced into alignment with the determined orientation of the surface.

The user selection may be of any desired two dimensional region. The user selection of a two dimensional region may be forced into alignment with a true space horizontal and a true space vertical based on the determined orientation of the surface.

Where the region is a true space circle, the user may select the region by selecting first and second points defining the circle, for example by identifying each point separately, or by dragging from one point to the other. The two points may be the centre and a point on the circumference, or two diametrically opposite points on the circumference.

In some embodiments the region may be one dimensional (i.e. a line on the surface). A one dimensional region may be selected by identifying each end of the region, for example by identifying each end separately, or by dragging from one end to the other. The user selection of a one dimensional region may be forced into alignment with a true space horizontal or true space vertical based on the determined orientation of the surface.

As shown in FIG. 8, the instrument may automatically determine a true space measurement associated with the selected region and display that measurement. The type of measurement to be made may be selected in the selection options box 84. The user may select “Perimeter” or “Area” or other suitable measurement type. In the example shown, the user has selected “Area”, as indicated by the selection marker 96. The measured area is displayed as indicated at 96′.

FIG. 9 illustrates an embodiment enabling replication of a user selection. The replication may either be manual (e.g. by a user issuing a “copy” instruction to copy the selection) or automatic (e.g. by the instrument detecting like image regions based on comparison of image data within the user selection with image data elsewhere on the surface).

A user may initially select a first region 97 on a surface 98. In the example shown, the user has selected a window 99. By comparison of the image data within the first region 99 with image data elsewhere on the surface 98, the instrument detects further regions having similar properties to the first region. A second window 100 is detected and found to have similar image properties and true space properties to the first window 99. A replica of the user selection is created and aligned with the second window 100. Note that the true space size of the replica selection is the same as the true space size of the original user selection. The displayed size of the original and replica user selections will however be different due to the perspective of the image.

As indicated by the dashed lines 101 and arrow 102 in FIG. 9, the instrument may automatically extended the top and bottom edges of the selected region 97 to identify like regions at the same height. Similarly, the instrument may extend the sides of the selected region 97 to identify like regions with the same vertical alignment.

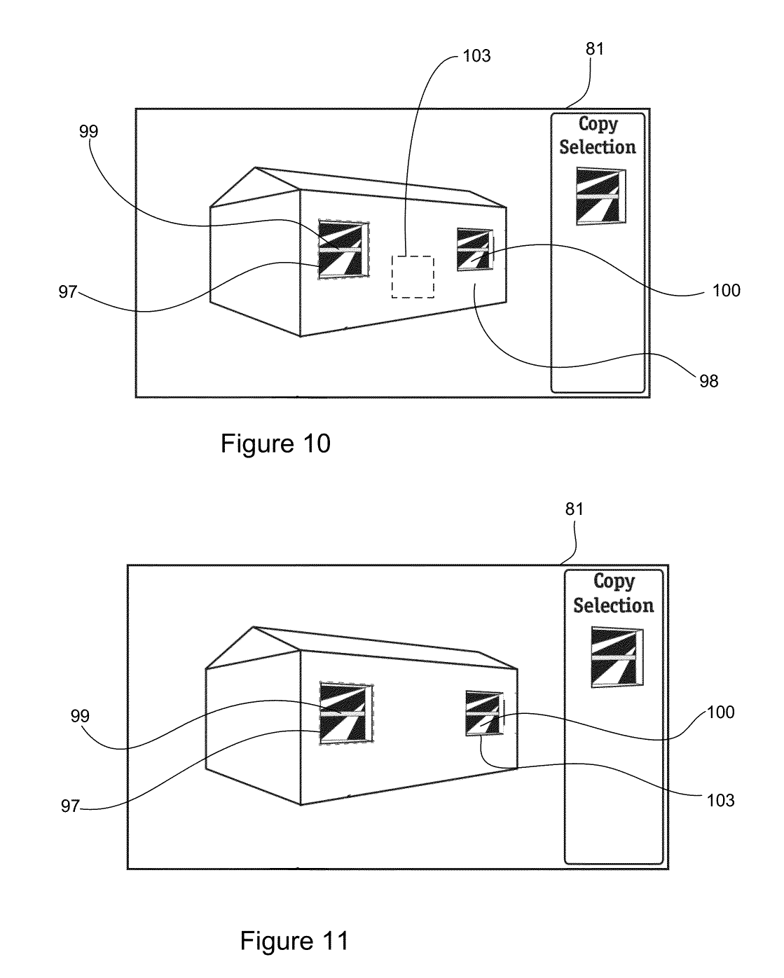

FIGS. 10 and 11 illustrate a manual method of replicating the selection. In this method, the user issues a copy instruction and the instrument displays a replica selection 103 overlaid on the image. The user may then move or reposition the replica selection 103 to align it with the like region 100. As the replica selection is moved, its displayed size will automatically change to reflect its position on the displayed image. Its true space properties remain the same. FIG. 11 shows the replica selection 103 manually aligned with the like region, i.e. second window 100.

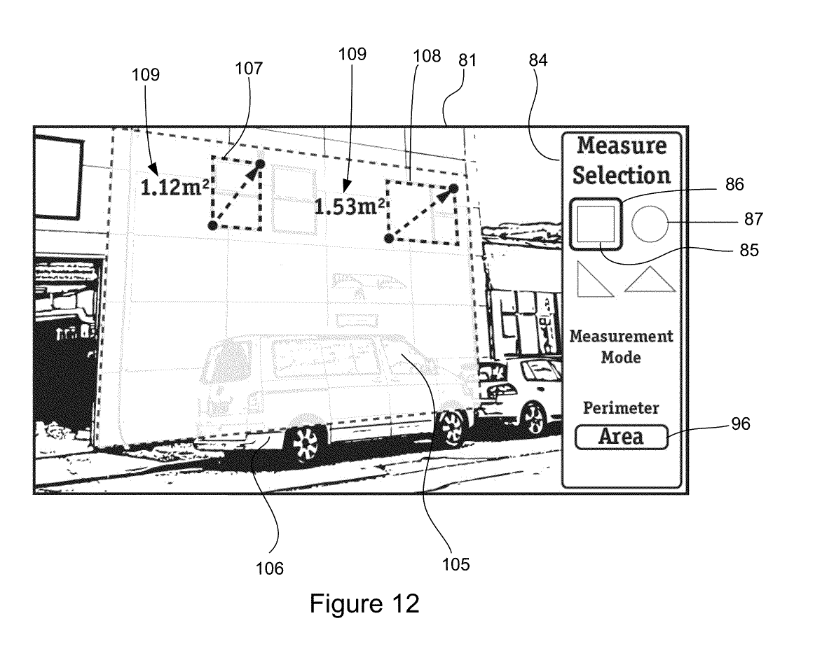

FIG. 12 shows an embodiment where a plane 105 is identified despite being partially obscured in the image by an obstruction, in this case a vehicle 106.

Multiple selections 107, 108 may be made by the user, and measurements or dimensions 109 associated with each may be displayed. Further, selections may be positioned partially behind, or even completely obscured by, the vehicle 106.

The instrument may also allow the user to adjust the determined orientation of the surface or the forced alignment of the user selection. This may be useful where the surface is irregular, or for some other reason it is difficult to determine its orientation accurately by any of the methods described in this specification.

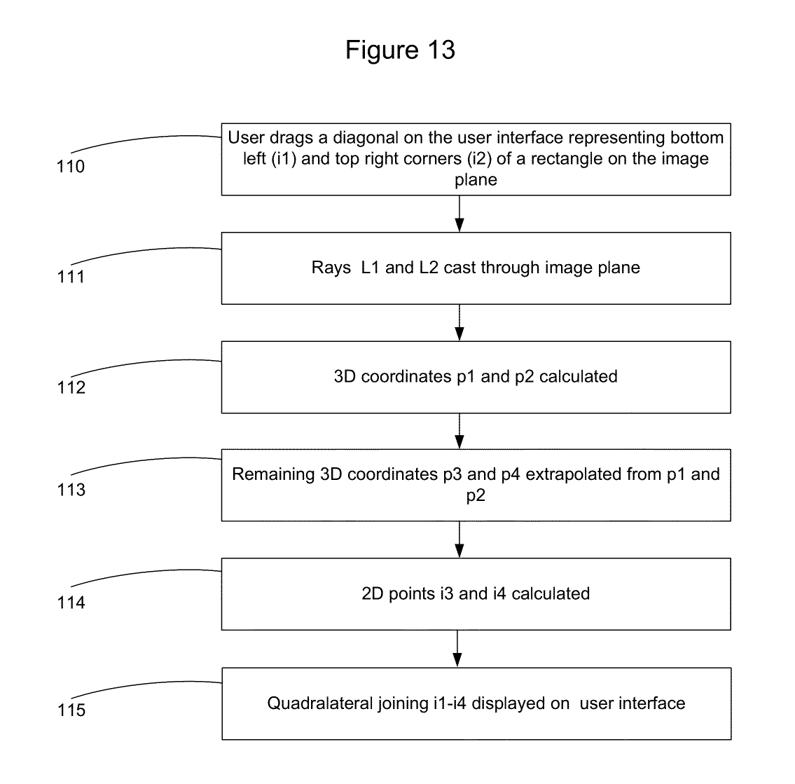

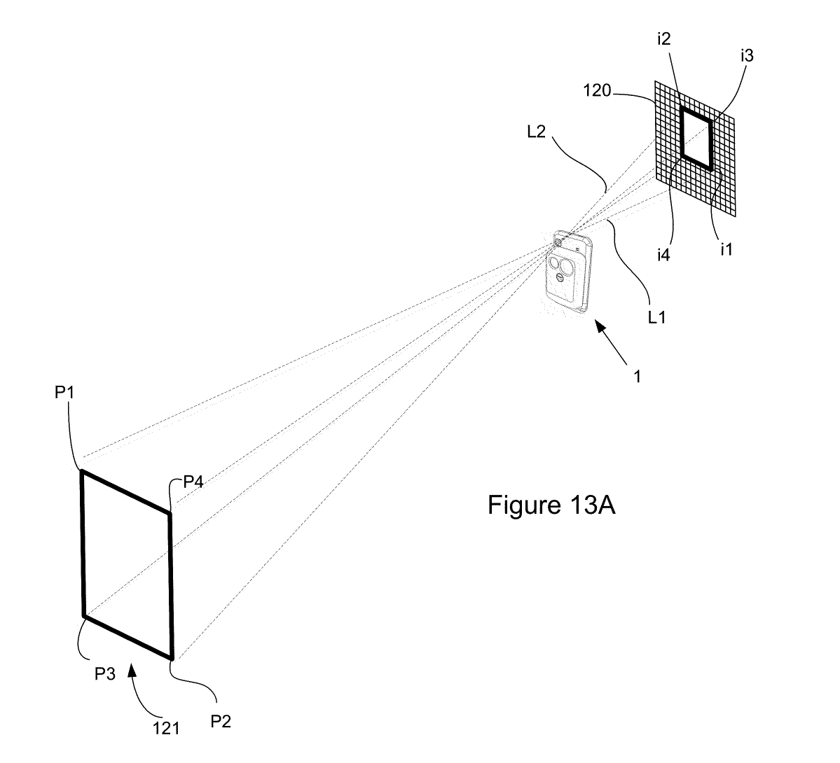

FIG. 13 is a flow chart illustrating an example of how a user's selection can be forced into alignment with the real-world plane of the image object. In the following example, the user wishes to measure a real-world rectangle (for example a window on a target plane) appearing on the user interface as an irregular quadrilateral. Assuming a pinhole camera model, such as shown in FIG. 13A, with the centremost pixel (0,0) of the image plane 120 representing the target point captured by the mobile handheld instrument's laser rangefinder on the real world target plane 121.

In true space three dimensional coordinates, the location of the mobile handheld instrument may be taken to define the origin (0,0,0) of the local 3D coordinate system. When a user captures a target point, the target point is thus defined as (0,0,d), where d represents the distance between the mobile handheld instrument and the target point as measured by the laser rangefinder.

At step 110, a user drags a diagonal in image space on the user interface, defining the bottom left and the top right corners of the irregular quadrilateral (representing the real world rectangle) that the user wishes to measure. Preferably, the two corners i1, i2 represented by the diagonal are aligned with two corners (e.g. the bottom left and top right corners) of a real-world object (for example a window) as closely as possible.

At step 111, rays L1 and L2 are cast from the optical centre of the pinhole camera with 3D position (0,0,0) through i1 and i2 on the image plane. The rays L1 and L2 can be defined using linear equations.

A target plane 105 can be mathematically defined by the normal of the plane and a point lying on the plane. Methods for determining the orientation of a target plane are discussed in more detail elsewhere in this specification. Referring to step 112, real world 3D coordinate P1 corresponding to 2D image coordinate i1 can thus be found by calculating the projection of L1 into the real-world plane 121. Similarly the real-world coordinate P2 of image coordinate i2 is calculated by the projection of L2 into real-world plane 121.

At step 113, the remaining corners of the rectangle are extrapolated from P1, P2 and the calculated orientation of the real world plane. For example if P1 has real world 3D coordinates (x1,y1,z), and P2 has real world coordinates (x2,y2,z), P3 and P4 will have real world coordinates (x1,y2,z) and (x2,y1,z) respectively.

At step 114 P3 and P4 are then projected back through the optical centre to the image plane to find 2D points i3 and i4.

At step 115, a quadrilateral connecting i1-i4 is displayed on the user interface. A quadrilateral representing a real-world rectangle is shown in its correct perspective, as defined by the perspective of the image plane. Thus, a user can easily define a rectangle on the target plane which is forced into the proper alignment.

A homography matrix can be defined which represents the projective transformation matrix between the image plane and the real-world target plane. This simplifies the projection of further pixel coordinates onto their corresponding plane coordinates.

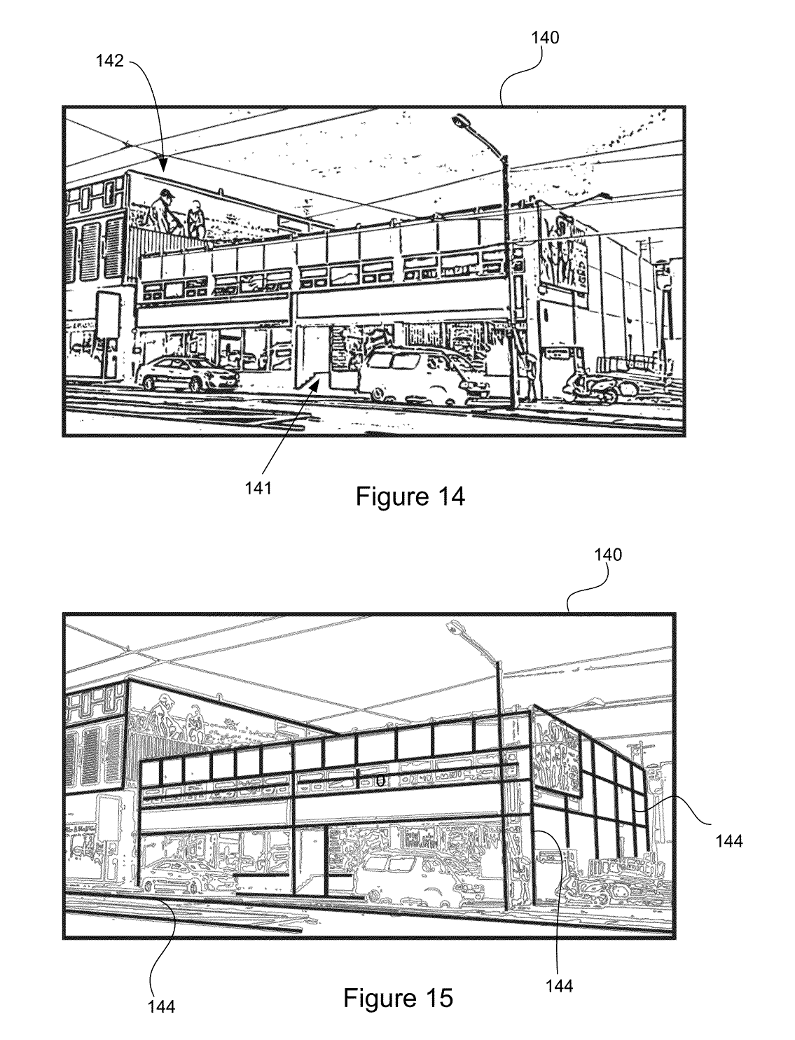

In any method described in this document, the orientation of a plane or surface may be determined by one of several suitable methods. The method of FIGS. 14 to 16 is preferred because it requires only a single data capture. However, other methods are described further below. Still further methods may occur to the skilled reader.

FIG. 14 shows an image recorded by the instrument 1. The image 140 includes buildings 141, 142. In one embodiment the instrument includes spatial sensors sufficient to define a three dimensional position of at least one point in the image. The positions of other points, and the orientations of surfaces in the image, can be determined by analysis of the image data.

Many surfaces will include numbers of edges or lines, not just at their intersections with other surfaces, but also at joins between panels or other building structures, windows, doors etc. In many cases there will be numerous edges or lines, and many of these will be either horizontal or vertical in true space.

The edges or lines present in the image may be detected by any suitable known edge extraction techniques. Such techniques are well known and need not be discussed further in this specification.

FIG. 15 shows the image 140, with various edges or lines having been detected, as indicated by the bold lines 144 overlaid on the image. The detected edges or lines include various vertical lines and various horizontal lines. Depending on the orientation of the surfaces on which those edges lie, these vertical and horizontal lines may be slanted within the image, due to the image perspective.

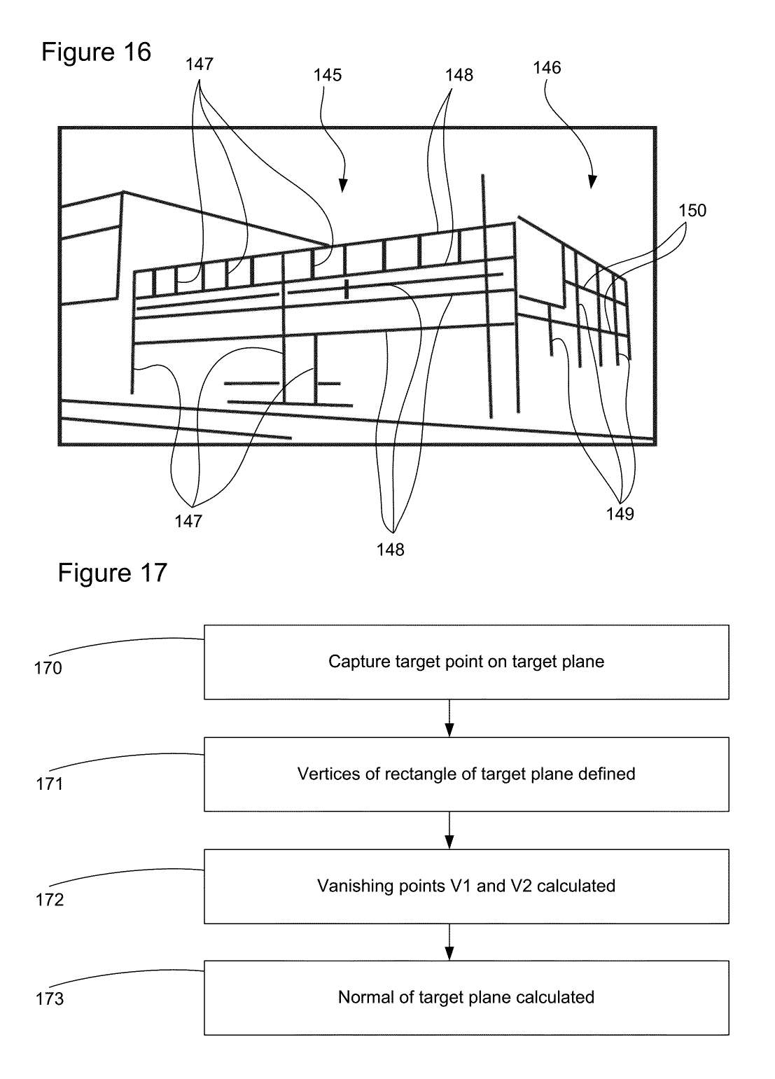

FIG. 16 shows the set of extracted edges, with the image data having been removed. The detected lines on the right hand building 141 lie on a first surface 145 and a second surface 146. The lines on the first surface 145 include a plurality of vertical lines 147 and a plurality of horizontal lines 148. Similarly, the lines on the second surface 146 include a plurality of vertical lines 149 and a plurality of horizontal lines 150.

The system may make assumptions about the orientations of the surfaces. For many purposes, we can assume that the two surfaces 145 and 146 are vertical surfaces. In some instances of captured image data there may be surfaces (e.g.

floors, ceilings etc) that can be assumed to be horizontal surfaces. These assumptions may be overridden by a user where necessary.

In other embodiments, the user may identify properties of surfaces, for example by identifying a surface as a vertical, horizontal, planar or cylindrical surface.

These assumptions and or user-input information may be used to aid the determination of surface orientation.

The extracted lines 147, 148, 149, 150 may be used to determine orientation using a “vanishing point” method, which will now be described with reference to FIGS. 17 to 18D.

A plane in a three dimensional coordinate space can be defined by a point S lying on the plane and a normal vector n orthogonal to the plane. The normal vector n orthogonal to the plane defines the orientation of the plane in 3D space. FIG. 17 is a flow chart illustrating the steps of determining the normal (and therefore the orientation) of a target plane.

At step 170, a target point 174 lying on the target plane 179 is captured using the mobile handheld instrument.

At step 171, the vertices of a quadrilateral defining the target plane are defined. FIG. 18B shows vertices 174-178. As described above, these vertices defining the target plane can be either user-defined or automatically generated. In most cases, on the raw image, the points appear as vertices of an irregular quadrilateral. In true space, the four points are the intersections of two sets of parallel lines that are orthogonal to each other.

The normal of the target plane can be calculated using the vanishing points of the two sets of orthogonal parallel lines. A vanishing point is a point where two or more lines that are parallel in true space appear to meet in image space. At step 172, vanishing points v1 and v2 are calculated by finding the intersection of the sets of parallel lines from the quadrilateral defined by vertices 174-178. FIG. 18C represents the vanishing points calculated from the quadrilateral.

At step 173, the normal 180 of the plane is calculated by the cross product of a first vector from an origin point to the first vanishing point v1 and a second vector from the origin to the second vanishing point v2. The origin point may be taken as the target point where the laser rangefinder strikes the target plane. Alternatively the origin point may be taken as the instrument centre, since the vanishing points will generally lie at infinity so the distance between the device and the target is not significant for the definition of the normal direction to the plane.

The target point 174 captured by the laser rangefinder lies on the target plane, with three dimensional coordinates (0,0,d), with d representing the distance to the target point from the location of the mobile handheld device. Thus, from the equation of the normal and a point lying on the plane, the target plane can be mathematically defined.

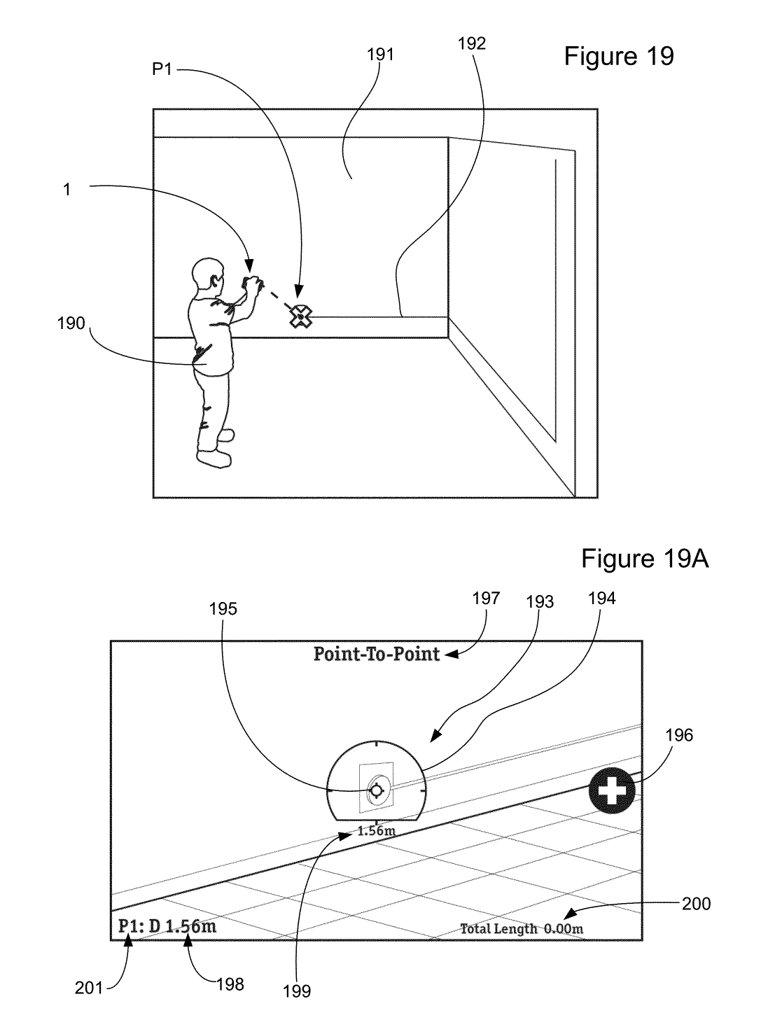

FIGS. 19 to 22A show a further data capture method in which measurement or dimensional data is overlaid on the display. This method is illustrated by way of example, showing the measurement of a path along the walls of a room. Such a method might be used, for example, by an electrician wishing to determine the path length between two electrical fittings.

In FIG. 19, the user 190 uses the instrument 1 to capture data relating to a first point P1 on a first wall 191 of a room. The desired path of electrical cable is shown by line 192. FIG. 19A shows the display of instrument 1 as the point P1 is captured. The display shows a marker 193 including an outer element 194 and an inner element 195, which assist the user in aligning the instrument 1 with the target point. A capture button 196 is displayed on the touch screen display. When actuated by the user 190, this will cause capture of data relating to P1. An overlaid capture mode indicator 197 indicated that the instrument 1 is now in “Point-To-Point” mode. The instrument 1 determines a distance from the instrument 1 to the point P1, and this may be displayed at any suitable position 198, and/or may be associated with the marker 193 at position 199. In the example shown, this distance is determined as 1.56 metres. A length indicator 200 may also be displayed. This indicator will read zero, as shown, until two points have been captured. A point counter 201 may also be displayed. Each point may be uniquely identified, which will aid the user in both the data capture phase, but also in later alterations of the data set, as will be discussed below.

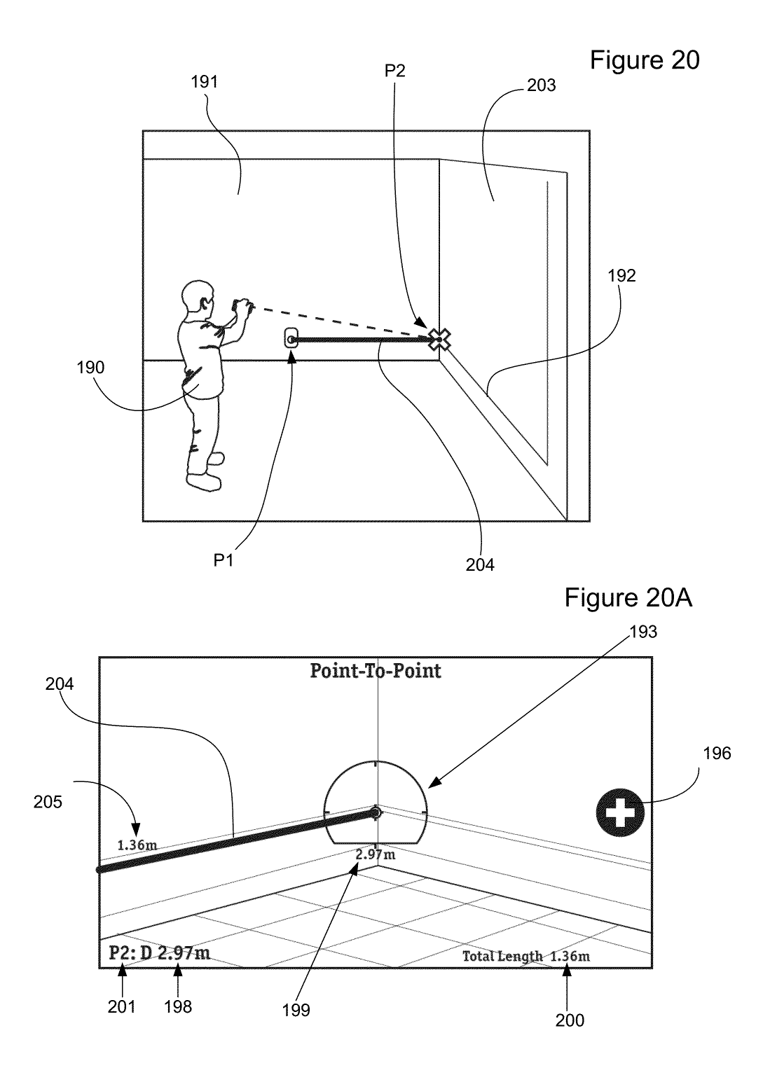

FIG. 20 shows the user 190 capturing a second point P2, which in this example is positioned at the corner between the first wall 191 and a second wall 203. The path between points P1 and P2 is shown in bold line 204 to indicate that this path has now been measured.

FIG. 20A shows the display of instrument 1 as the point P2 is captured. The marker 193 is now aligned with P2. The point distance indicators 198, 199 show that P2 is 2.97 metres from the instrument 1. The point counter 201 shows that this is the second point in the data set.

Further, in FIG. 20A the length indicator 200 has been updated to show the total measured length over the path from P1 to P2. This is measured as 1.36 m. Further, the path length between P1 and P2 may also be overlaid on the display at a point associated with the path between P1 and P2. As shown in FIG. 20A, this path length may be displayed at point 205, just above the path 204.

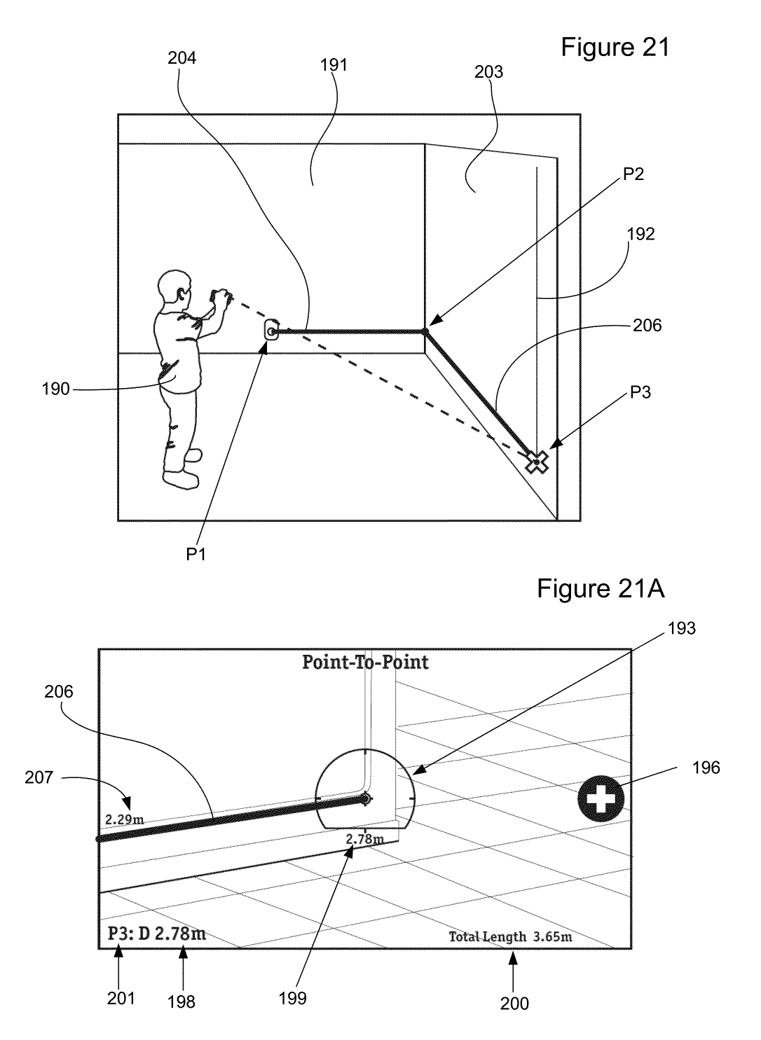

FIG. 21 shows the user 190 capturing a third point P3, which in this example is positioned at a point on the second wall 203. The path between points P1 and P3 is shown in bold line 204, 206 to indicate that this path has now been measured.

FIG. 21A shows the display of instrument 1 as the point P3 is captured. The marker 193 is now aligned with P3. The point distance indicators 198, 199 show that P3 is 2.78 metres from the instrument 1. The point counter 201 shows that this is the third point in the data set.

Further, in FIG. 21A the length indicator 200 has been updated to show the total measured length over the path from P1 to P3. This is measured as 3.65 metres. Further, the path length between P2 and P3 may also be overlaid on the display at a point associated with the path between P2 and P3. As shown in FIG. 21A, this path length may be displayed at point 207, just above the path 206.

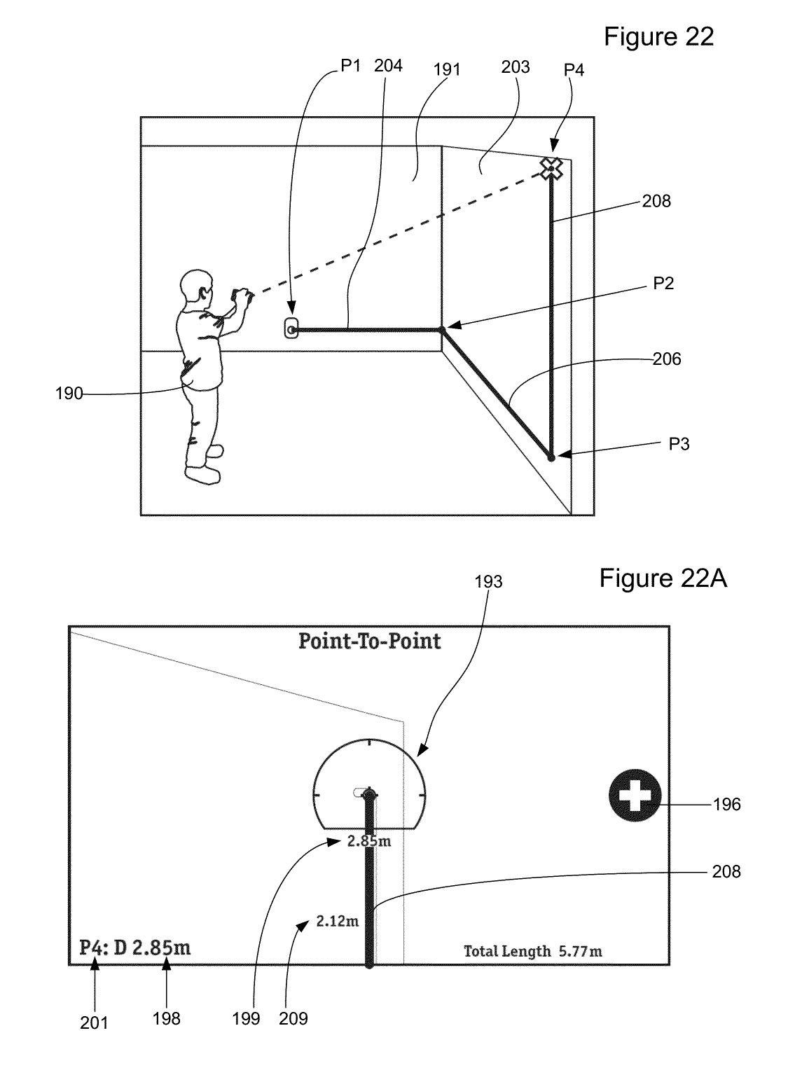

FIG. 22 shows the user 190 capturing a fourth point P4, which in this example is positioned at another point on the second wall 203. The path between points P1 and P4 is shown in bold line 204, 206, 208 to indicate that this path has now been measured.

FIG. 22A shows the display of instrument 1 as the point P4 is captured. The marker 193 is now aligned with P4. The point distance indicators 198, 199 show that P4 is 2.85 metres from the instrument 1. The point counter 201 shows that this is the fourth point in the data set.

Further, in FIG. 22A the length indicator 200 has been updated to show the total measured length over the path from P1 to P4. This is measured as 5.77 metres. Further, the path length between P3 and P4 may also be overlaid on the display at a point associated with the path between P3 and P4. As shown in FIG. 22A, this path length may be displayed at point 209, beside the path 208.

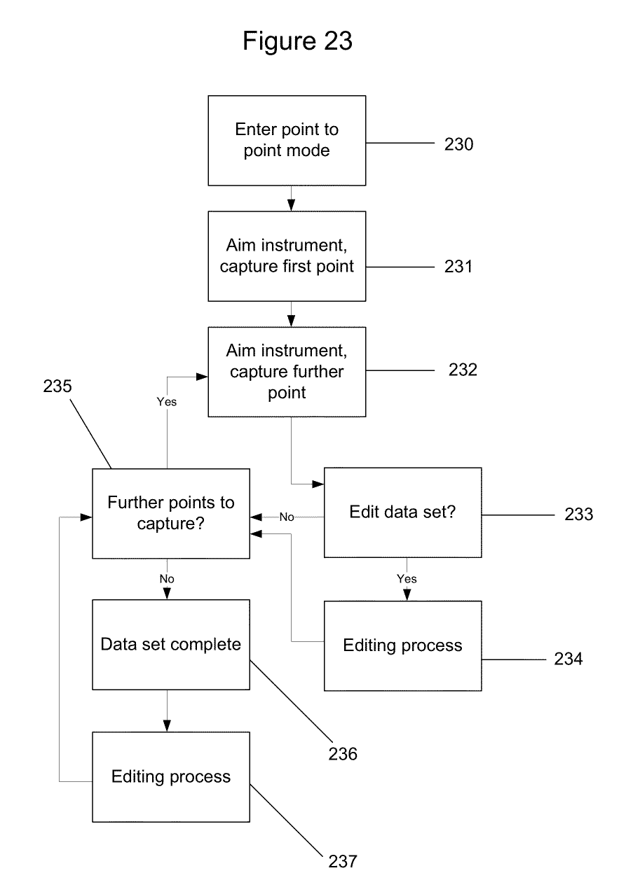

FIG. 23 is a flow chart illustrating the steps in the point to point method of FIGS. 19-22A. At step 230, the user enters the “point to point” mode. The instrument may now display the point to point mode indicator 197. At step 231, the user aims the instrument at a first point P1, and issues a capture instruction (e.g. using any suitable button, user input device, speech command etc.). In response to the capture instruction, the instrument captures a spatial data set associated with the first point P1.

Desirably, the final data set will include an image file encompassing the various points measured. This can be achieved by capturing a sufficient number of images as the instrument is moved. This may be done by capturing an image at each data capture point P1, P2. However, a greater number of images may be needed, or a smaller number of images may be sufficient, depending on the positions of the data capture points. It may not be necessary to capture an image for every point in the point to point mode. Alternatively, it may be necessary to capture further image data outside of the user-instigated capture process. This can be achieved by suitable methods described below.

At step 232, the user aims the instrument at a further point P2, and issues a further capture instruction. In response to the further capture instruction, the instrument captures a spatial data set associated with the further point P2.

Optionally, at this point the user may have the option of editing the data set at step 233. For example, the user may be permitted to delete one or more data capture points from the data set at step 234. Other editing steps include reordering the data points, and/or moving one or more data points.

When the user has finished editing, or if the user does not wish to edit the data points, the user may return to step 232 and capture further data points until it is determined at step 235 that the data set is complete 236. At this point, the user may be given an opportunity at step 237 to edit the data set, by deleting, reordering, moving, or adding a target point, or defining a subset of the target points. The user may also be given the option to return to the data capture process, to add further points to the data set after this editing step.

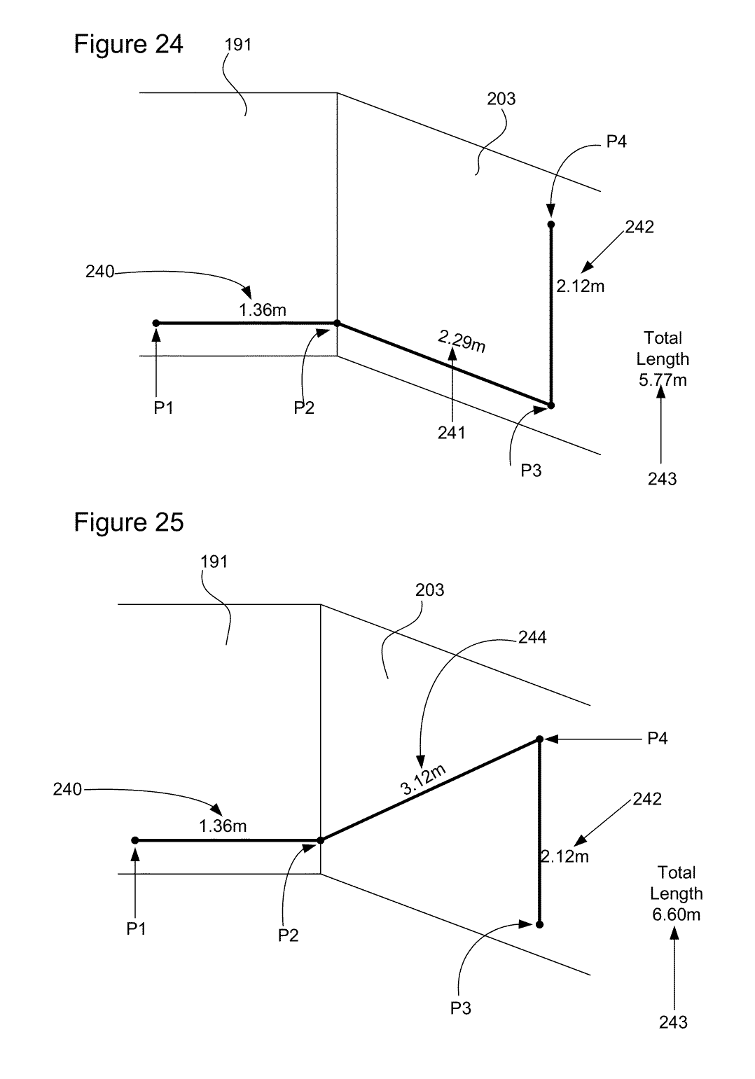

By deleting and/or reordering the data points, the user changes the connections between points. The displayed data preferably automatically updates to reflect these changes. FIGS. 24 to 26 demonstrate the effects of the edited data set on displayed data.

FIG. 24 shows a displayed image with a path between measured points P1, P2, P3, P4 overlaid. Each point P1, P2, P3, P4 may be marked by a suitable marker. The displayed image may be formed from a single captured image, or may be stitched from several images captured by the instrument 1.

The measurement data 240, 241, 242, 243 similar to that of FIGS. 19A, 20A, 21A and 22A is now overlaid on the image of FIG. 24.

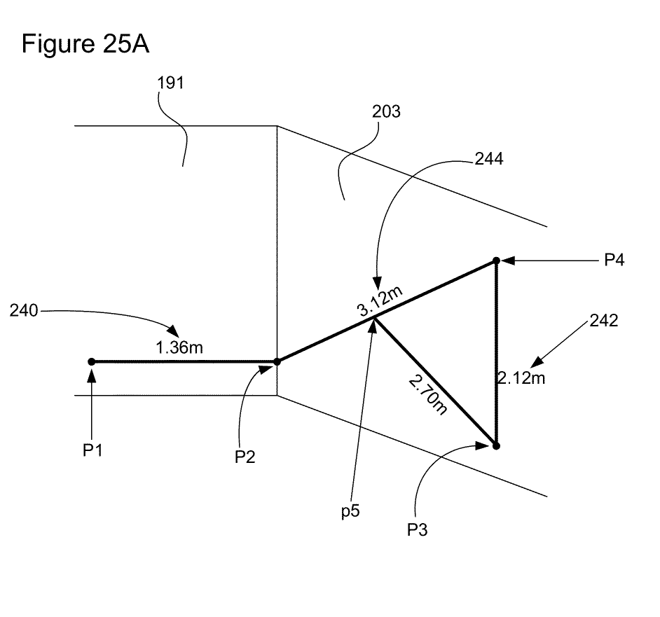

FIG. 25 is a similar view to FIG. 24, but shows how the displayed data has been updated by the user. In this case, the user has reordered the data points such that the measurement path is now from P1 to P2 to P4 to P3, rather than P1 to P2 to P3 to P4 as it was in FIG. 24. The displayed path is altered. The displayed measurement data is also updated, with a new measurement 244 of 3.12 metres now displayed for the path P2 to P4. The total path length is also updated for the edited data set, and is now displayed as 6.60 metres.

FIG. 25A is a similar view to FIG. 25 and shows another type of alteration or editing step that a user may employ. This drawing demonstrates how any point on a line between two known points is itself a known point and can be used as a basis for any kind of desired measurement. For example, a user may wish to calculate a distance between the measured point P3 and a user-defined point p5 which is positioned on a line between the known measured points P2 and P4. The device may allow a user to define any point on a line between two known points as the basis for a measurement or a selection. In general, measurements and selections may be based on any desired number of user defined points, so long as the coordinates of each user defined point can be determined from already known points, lines, curves, planes or other surfaces. As shown, the device may display the calculated distance, with the distance between points P3 and p5 displayed as 2.70 m.

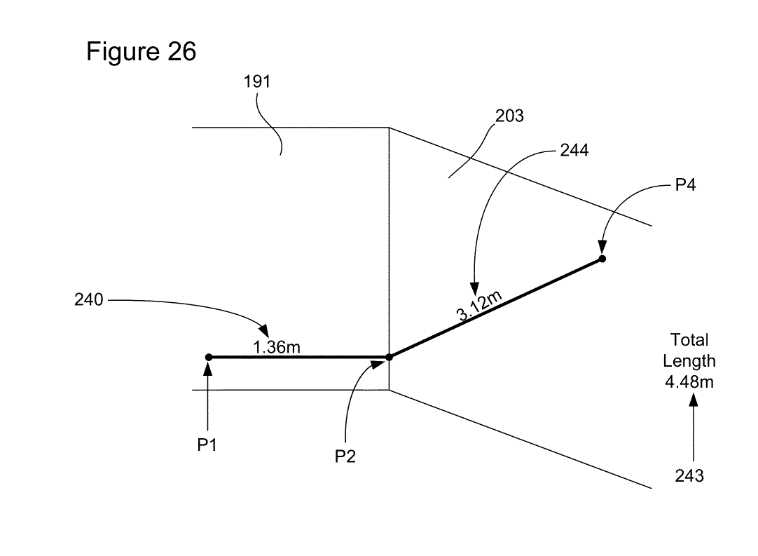

FIG. 26 is a further similar view to FIG. 24, but shows how the displayed data has been updated by the user. In this case, the user has deleted the data point P3 such that the measurement path is now from P1 to P2 to P4, rather than P1 to P2 to P3 to P4 as it was in FIG. 24. The displayed path is altered. The displayed measurement data is also updated, with a new measurement 244 of 3.12 metres now displayed for the path P2 to P4. The total path length 243 is also updated for the edited data set, and is now displayed as 4.48 metres.

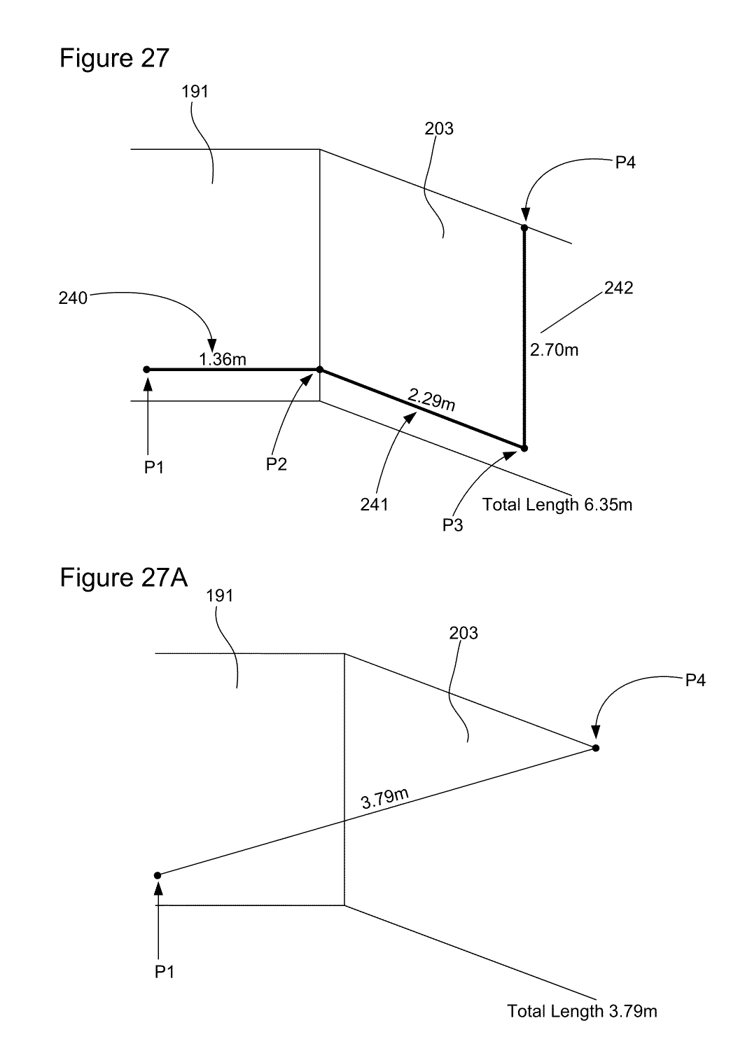

FIG. 27 is another similar view to FIG. 24, but shows how the displayed data has been updated by the user. In this case, the measurement path remains the same, but the user has moved point P4 to the top of the second wall 203. The displayed path is extended up to the new position of point P4. The displayed measurement data is also updated, with the measurement 242 being updated to 2.70 metres and the total path length 243 now displayed as 6.35 metres.

FIG. 27A illustrates a further view, demonstrating that the measurement data is not limited to lines lying on planes in the image. In this example, points P2 and P3 have both been removed from the data set. The displayed path now includes a single line from P1 to P4. The displayed measurement data is also updated, with the measurement from P1 to P4 being updated to 3.79 metres and the total path length now displayed as 3.79 metres.

FIGS. 24 to 27A illustrate simple examples of how the data set may be edited by the user. More complex data sets may be freely edited and the paths and measurements updated appropriately.

In general, the measurements calculated from the captured spatial data may be overlaid in any suitable position. Preferably the overlaid data is displayed in a position associated with at least one of the relevant target points. Where the calculated distance is a distance between two points, it may be overlaid near a line connecting those points.

The point to point method of FIGS. 19 to 27A relies on knowledge of the instrument position for each measurement. The Applicant's instrument is a handheld instrument, operated freehand without a fixed support (such as a tripod). The positioning data available from a GPS receiver or similar positioning receiver could be used to determine the position for each measurement. However, in practice the GPS data is not sufficiently accurate for many applications, particularly for determining the movement of the apparatus between multiple data captures, such as is required in the point to point method of FIGS. 19 to 27A. Further, in some embodiments the instrument may not include a GPS or similar receiver.

The Applicant's instrument therefore preferably includes an arrangement for sensing the local movement of the instrument. In one embodiment this may be an inertial measurement unit (“IMU”) 210 (FIGS. 3 and 5) that is configured to monitor movement of the instrument 1 between data captures. This may be useful in the above point to point methods, but also in other methods disclosed herein.

The local movement sensing arrangement, or IMU, may include any arrangement of devices suitable to provide an accurate assessment of the instrument's movement between data captures. These devices may include accelerometers, gyroscopes and/or magnetometers. The IMU may have its own processor, or may rely on the processing capability of the processor already present in the instrument 1. Further, although shown in the drawings as a separate device, the IMU may draw on other devices in the instrument 1, including the orientation sensors 11, 48 for example. Further, the IMU may draw on the output of other sensors as inputs to its movement determination, or as a cross-check of its movement determination. For example, image data from one or more cameras, GPS data, further accelerometer data, compass data and barometric data may be used as inputs to the IMU, or as cross-checks against the IMU's movement determinations.

IMU's are commercially available and the workings of these devices need not be further discussed in this document.

The IMU capability may also be used in determination of a surface orientation, rather than relying on the vanishing point method described above. Where a user knows at the time of capturing data that a particular surface is of interest, the user may capture spatial data for three or more points on that surface. So long as the three or more points do not lie along a line, this will be sufficient data to define a plane.

For non-planar surfaces, a greater number of data points may be captured in this way and a surface fitted through those points.

In either case, the data points may be captured in a point by point mode where the user instructs each data capture. Alternatively, in a multipoint mode two or more data points may be captured automatically in response to a single user instruction (e.g. using the device to “paint” a surface with data points, capturing spatial data for each). The IMU may be used to monitor the device movement between data captures for any desired capture mode.

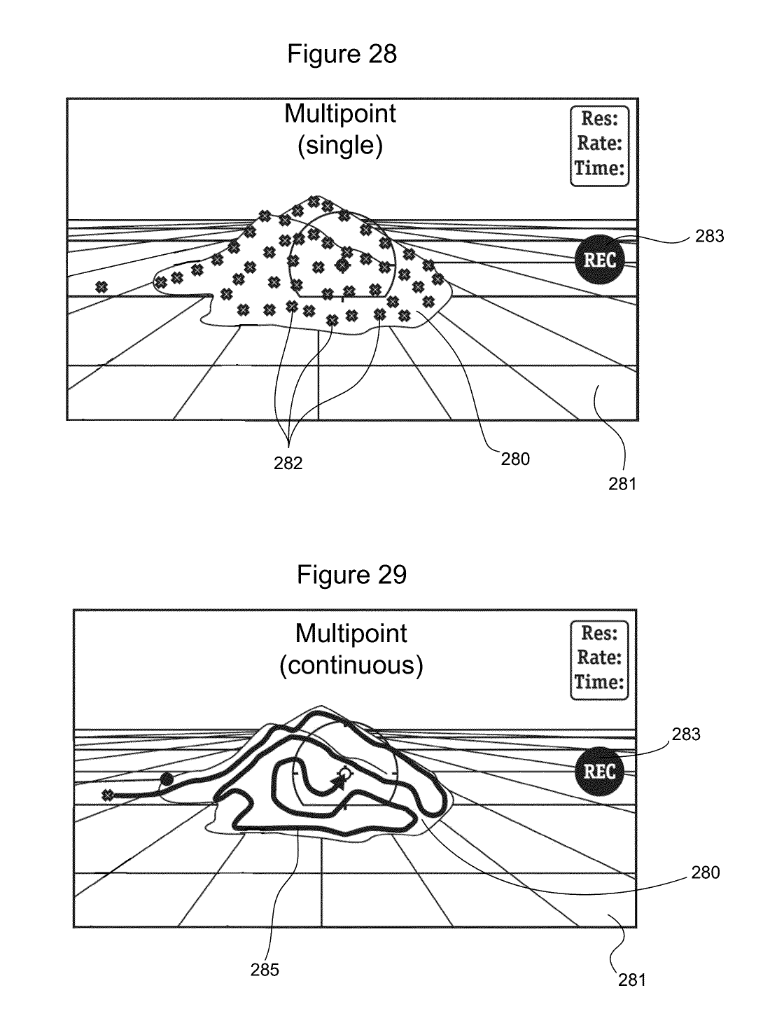

FIGS. 28 to 30 illustrate two multipoint modes. In each case the user is gathering data concerning a pile of material 280 on a relatively flat ground surface 281. For example the material may be an irregular pile of soil, gravel, cement or the like, and the user may wish to know the volume of material available.

In these methods, the instrument may again use the IMU to track the instrument's movement between data captures.

FIG. 28 shows the display for a multi point mode where a marker 282 is displayed at each target point for which data has already been gathered. Each marker remains overlaid on the live camera feed, in real time, at a position corresponding to its respective target point. This requires that the markers move on the display as the instrument 1 is moved by the user. As shown in FIG. 28, this enables a user to know where data has already been collected and to direct the device so as to gather data from unmeasured, or less full measured, regions.

In this multipoint method, data is preferably gathered substantially continuously by the instrument without the user having to instruct each data capture. In practice, this means that data will be periodically captured. Data may be gathered at any desired rate to give a suitable density of data points in a reasonable capture period. For example, around 1 to 20 data points may be captured per second. In some embodiments the capture rate may be adjustable by the user.

The user may issue a single capture instructions using the “record” button 283 and the instrument preferably continues to gather data until the user stops the data recording, for example by pressing the “record” button a second time.

FIG. 29 illustrates a similar data capture method to FIG. 28. However, in this embodiment the distinct markers 282 are replaced by a plurality of markers forming a continuous line 285 that is fitted to the target points from which spatial data has been captured.

In some embodiments similar data sets may be captured, with the user issuing a capture instruction for capture of each data set.

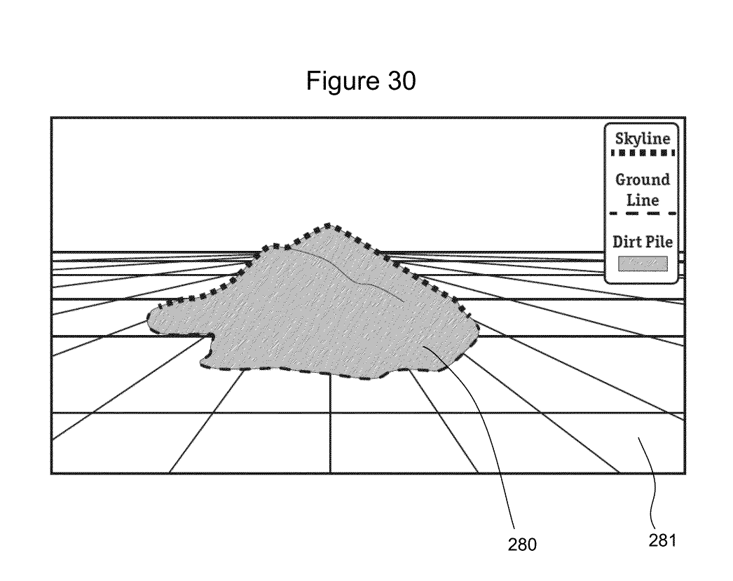

FIG. 30 illustrates the use of data categories, which may be defined at any suitable stage of the process. For example, default target categories, such as “ground”, “skyline”, “wall”, “roof”, “edge”, “surface”, “object” or the like may be provided. The user may also be permitted to define custom categories such as “gravel”, “dirt pile”, “pole” etc, depending on the end use of the instrument 1. The setting of a category may take place before or after data capture.

In one embodiment the user sets a category (e.g. “ground) and then uses the instrument to capture data points corresponding to that category. The user then changes the category (e.g. to “dirt pile”) and captures data points corresponding to that category. This continues until data has been captured for each desired category.

In another embodiment, the user may capture data before manually defining regions of an image file and selecting different categories for those regions.

In the example shown, the displayed image has three data categories—skyline, ground and dirt pile. This categorisation may help the instrument to display the data in a more helpful way (for example by colour coding the different categories).

Further, categorisation before data capture may aid the instrument in determining the boundaries between features captured in the image. The captured data sets together with the target categories associated with the captured data sets may be used to form a three dimensional model.

Further, in any of the methods disclosed herein, the displayed marker may have one or more display properties that associate that marker with one of the target categories. For example, the marker may be colour coded for a particular category, or each category may be associated with a different marker symbol, size, pattern or style.

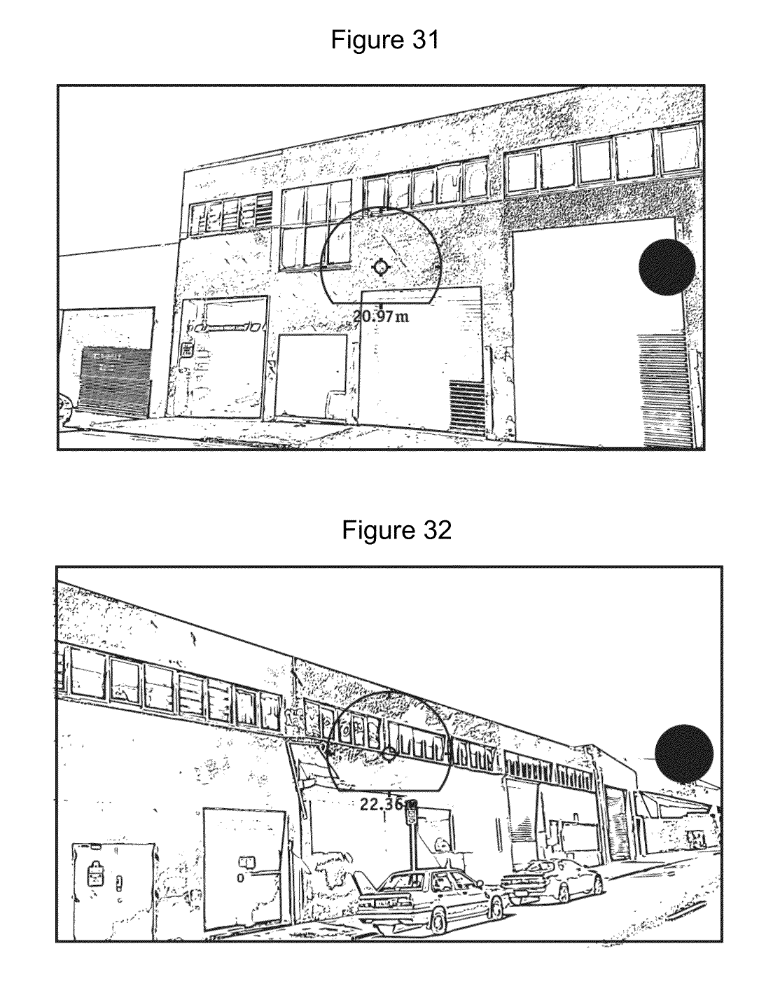

FIGS. 31 to 34B illustrate a further method involving the creation of an image file encompassing two or more measurement points.

FIG. 31 shows a first displayed view of the instrument 1, when capturing a first image and spatial data set. FIG. 32 shows a second displayed view of the instrument 1, when capturing a second image and spatial data set. In each case the marker is aligned with a target point during capture.

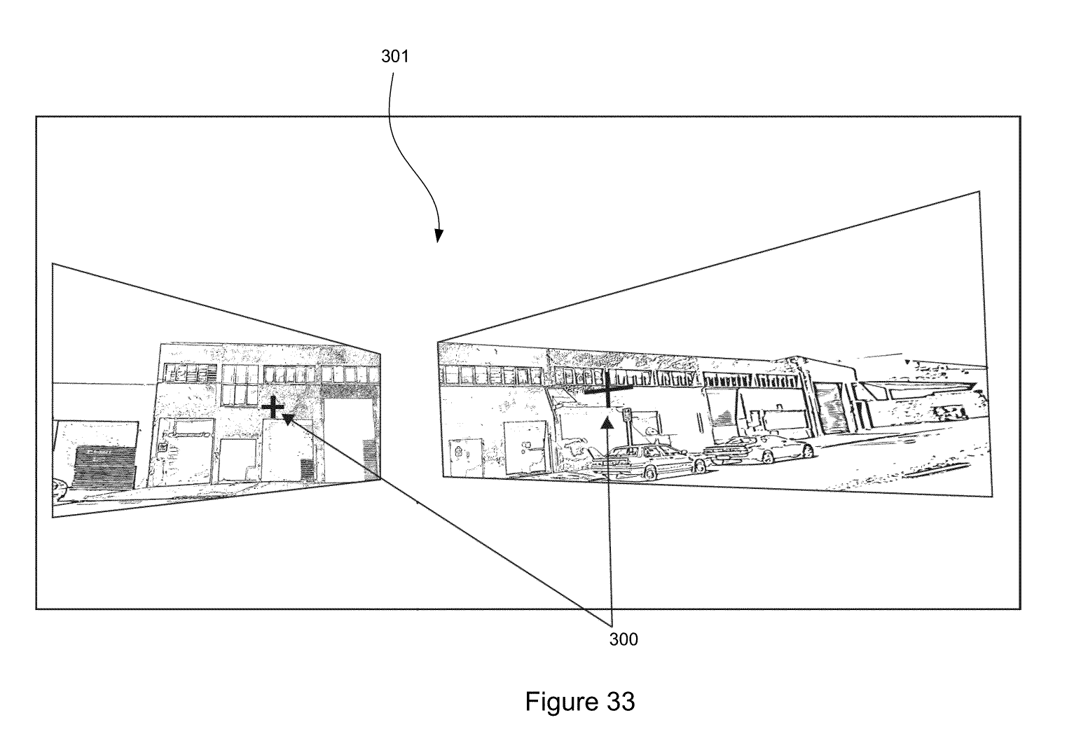

FIG. 33 shows an image file created by “stitching” the first image and the second image. This stitching process can be performed based on data from the IMU and/or by analysis of image features. Stitching algorithms are well known and need not be discussed in detail in this specification. The markers 300 corresponding to the first and second spatial data target points are shown. A gap 301 may exist between the first and second images. It is not necessary that the images captured in response to user capture instructions overlap. The device has sufficient spatial data to determine spatial information, such as distances between target points etc, even when the target points are separated by a distance (or subtend an angle) that is greater than the camera's field of view.

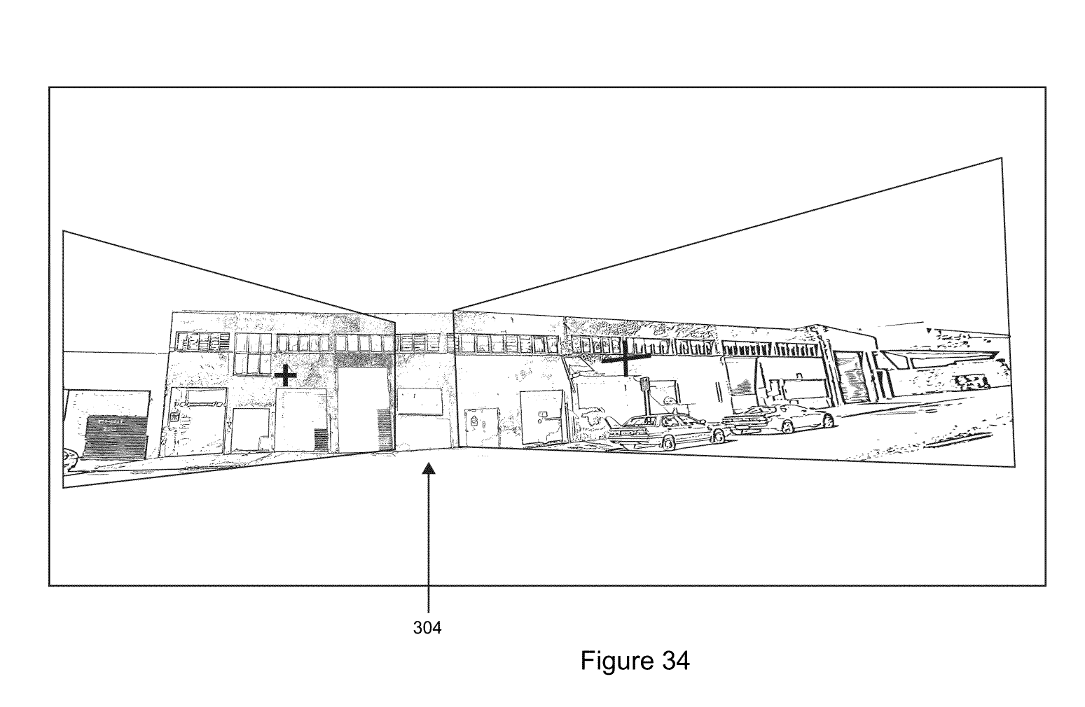

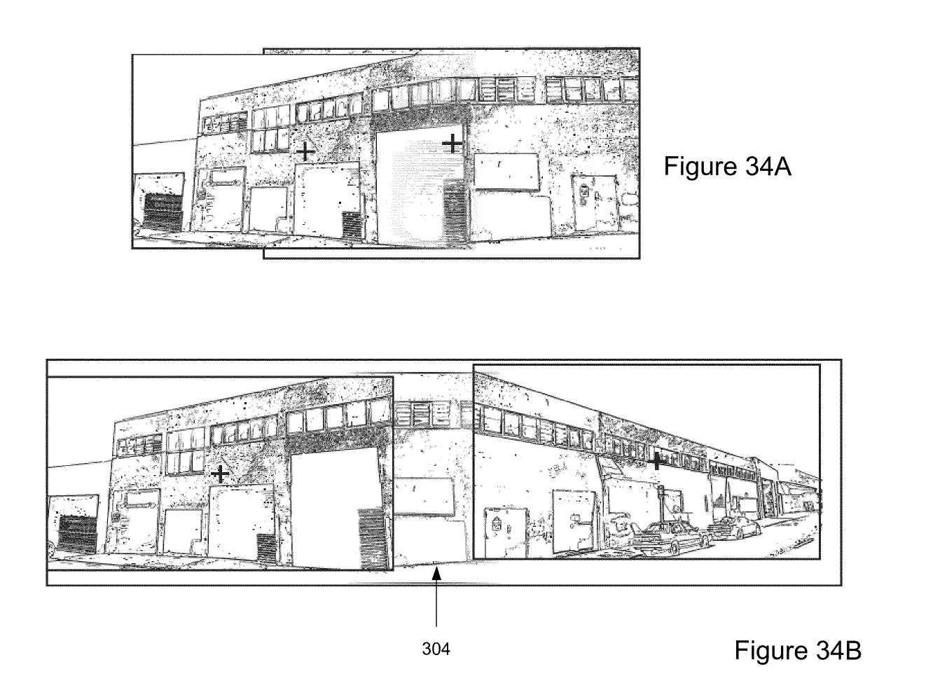

FIG. 34 shows a further image file created by “stitching” the first image and the second image. However, in this image file the gap 301 has been filled or interpolated with image data 304 automatically captured by the instrument 1. This provides a continuous image file encompassing all target points.

FIGS. 34A and 34B are similar views including stitched images. However, in these examples the images are stitched without the correction of their perspectives shown in FIGS. 33 and 34.

The automatically collected image data is preferably collected independent of the user capture instructions. It may include image frames collected periodically (e.g. continuously collected video data). Alternatively, to reduce the amount of data required, image data may be automatically collected when the movement of the instrument away from a position at which image data was last collected or captured exceeds a threshold. For example, the instrument may capture a first image at a first position, either automatically or in response to a user capture instruction. A further image should be captured before the instrument is moved such that the camera field of view does not overlap with that first image. A suitable threshold may be set at 20% overlap, or some other suitable level. When that threshold is exceeded a further image may be captured.

In any of the above methods requiring the instrument's position and/or orientation to be tracked between measurements, further inputs and/or assumptions may be used to enhance the performance of the IMU.

FIGS. 35, 36, 37 and 38 shows a user 310 holding an instrument 311. As shown, user's tend to hold the instrument with a straight or slightly bent arm, and to move the instrument between measurements without significantly altering the extension of their arm. This means that, if the user moves only their arm and not the rest of their body, the movement of the instrument can be assumed to lie on a surface 312 defined by the possible movements of the arm about the shoulder, with no or minimal changes in extension at the elbow. In a perfect model where the shoulder defines a fixed centre of rotation the instrument would move on the surface of a sphere. In practice the shoulder may not be a perfect centre of rotation, and the surface will be slightly more complex.

Performance of the IMU may be further improved by instructing users not to move their feet or bodies between measurements and to move the instrument by moving their arm about the shoulder, with no or minimal changes in extension at the elbow. This will result in user movements closer to the assumed movement.

In use, the IMU will provide data such as orientation and acceleration. The accuracy of the position data can be augmented by restricting allowable instrument positions to the surface 312, or allowable instrument movements to movements on the surface 312.

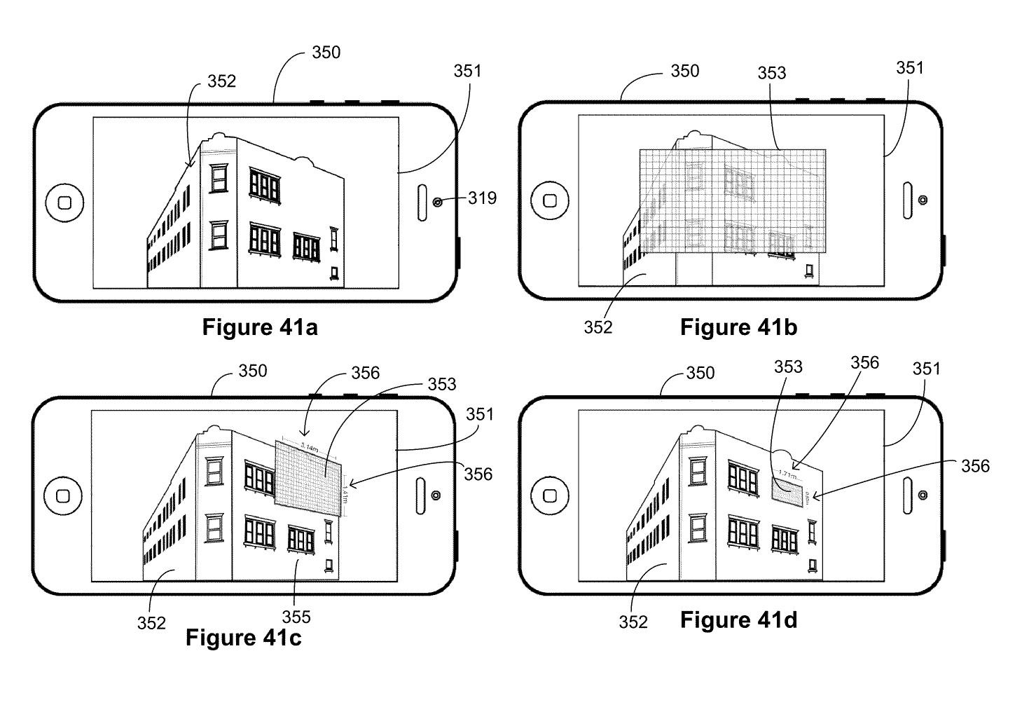

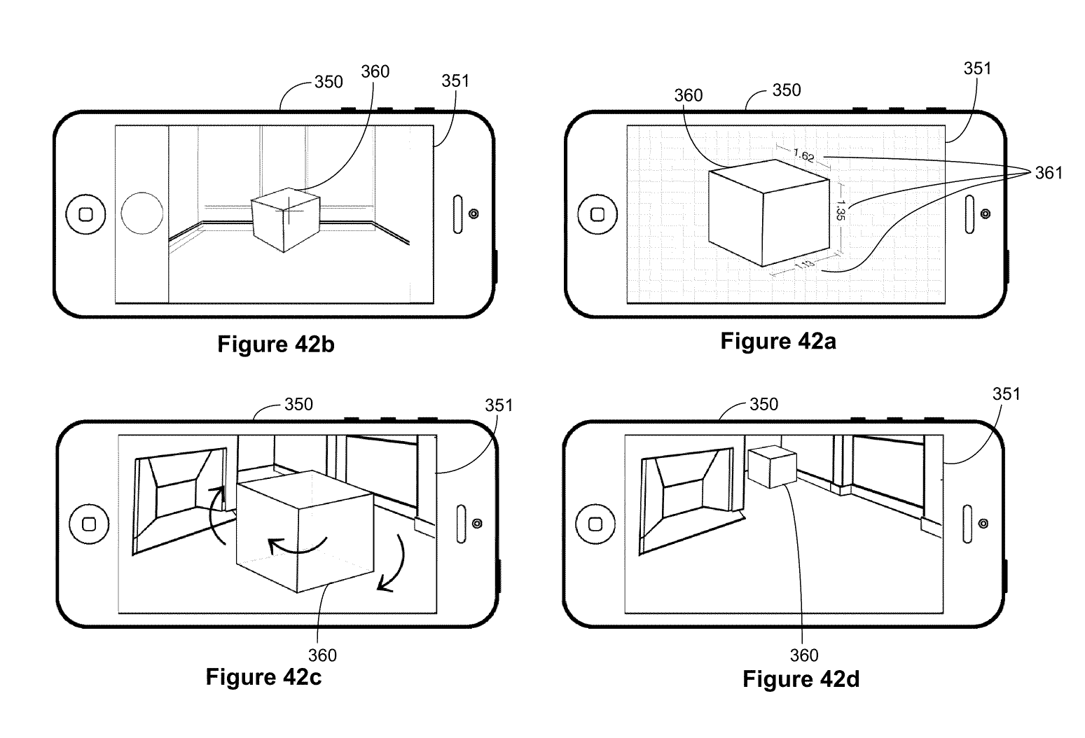

The performance of the IMU may be improved using data captured using a second camera facing back towards the user. Some Smartphones are now sold with a second, back-facing, camera (such as, e.g. the back-facing camera 319 shown in FIG. 41A).

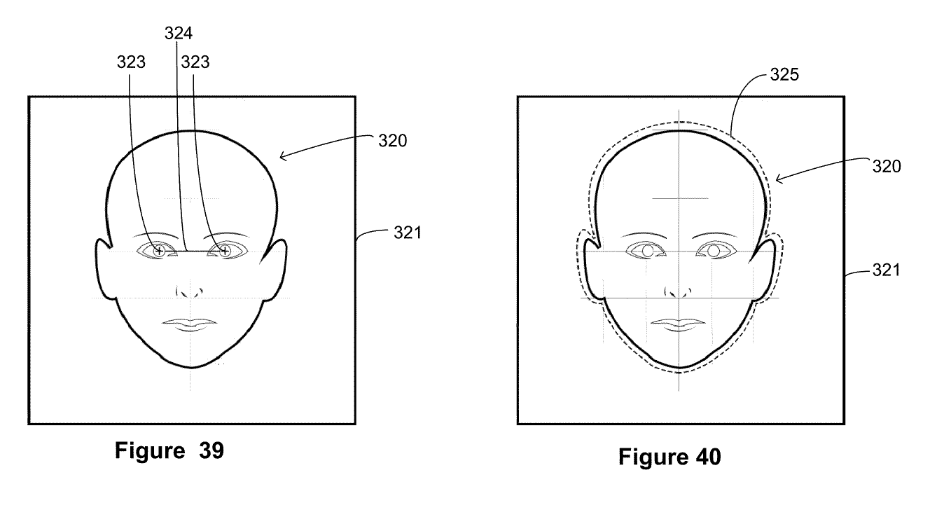

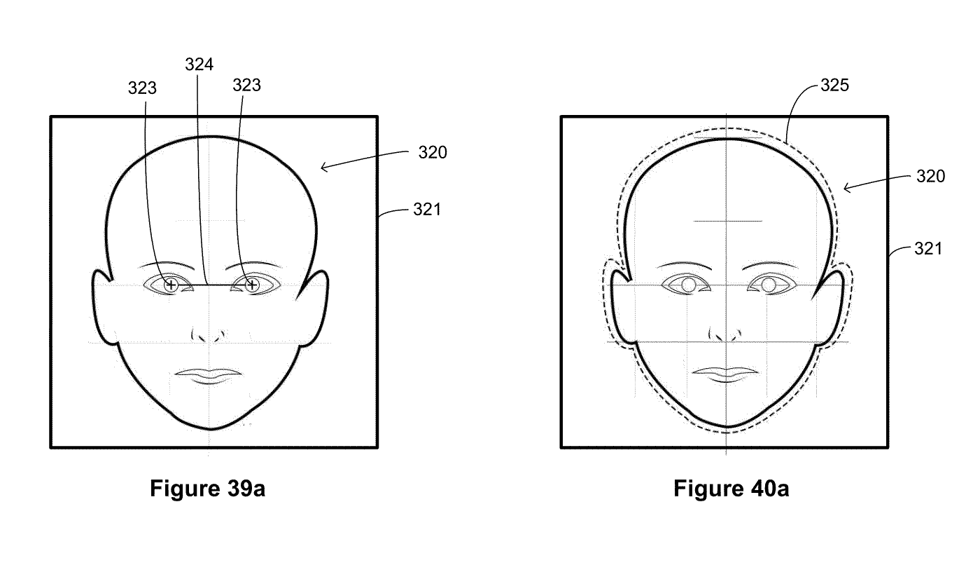

FIG. 39 shows data captured by a second camera facing towards the user. In practice, the user tends to look towards the device, as the user needs to look at the display while data is being captured. In the example shown, the user's face 320 is located within the image frame 321 and has a scale that is a function of the distance between the camera and the user's face. A scale or scale factor can be determined by examining the dimensions of the user's face. For example, as shown in FIG. 39, the instrument may automatically detect the user's pupils and determine a dimension between the centres of the two pupils (as illustrated schematically by markers 323 and line 324 in FIG. 39). Alternatively, as shown in FIG. 40 a perimeter 325 of the user's face, or any suitable portion of the user's face, may be automatically detected and an area within that perimeter may be determined.

FIGS. 39A and 40A are similar views to FIGS. 39 and 40. However, between measurements the user's face has moved closer to the second camera 319 and therefore occupies a greater proportion of the image frame 321. The dimension between the pupils 323, and the overall area within perimeter 325 have therefore increased.

These relative changes in dimension or scale may be used as inputs to augment performance of the IMU. Movements of the device towards or away from the user's face may indicate that the user is moving the device in a non-ideal manner that departs from the surface 312 of FIGS. 35 to 38. However, once detected using the back-facing camera, this can be compensated for, further improving performance of the IMU.

FIGS. 35A-D show an embodiment in which desired dimensions of an object can be determined. This method may be used for 2- or 3-dimensional objects of any required shape. At the time of measurement the object is a virtual object that does not yet exist, but a model of the object is overlaid on the display of the instrument and may be resized as appropriate until a user is satisfied with its size. The real world required dimensions of the object can then be determined and the final object made to size before installation.

FIG. 35A shows an image of a building 352 displayed on the display 351 of an instrument 350. The instrument 350 may be as in any of the embodiments described above. In the example shown a user wishes to determine the appropriate size of a billboard, painting, mural or some other 2-dimensional image or object to be displayed on or applied to a wall of the building.

In this embodiment the user has access to a model 353 of a desired billboard. The model 353 may be any suitable model, including a graphics file saved on the instrument. The graphics file may be generated by a designer or may be captured by photographing a physical image or object, or may be obtained or generated in any other suitable manner.

FIG. 35B shows the model 353 overlaid on the display 351, with the building 352 in the background. The model may be opaque, or as illustrated may have some transparency.

FIG. 35C also shows the model 353 overlaid on the display 351, with the building 352 in the background. However, in this view the perspective of the billboard model has been aligned with the perspective of a wall 355 of a building to which the billboard will eventually be mounted. Determination of perspective and alignment of rectangles and other shapes with correct perspective is discussed above, and any of those methods, or any other suitable methods, may be used in this embodiment.

FIG. 35D shows the real world dimensions 356 of the model 353 displayed on display 351. As shown in FIG. 35C, the model is 3.14 by 1.41 metres, and is too large for the available space on the building 352.

The real world dimensions of model 353 may be determined based on the position of the model within the displayed image, and using one or more of the instrument's spatial sensors to determine an appropriate scale to be associated with the model 353. For example, in FIG. 35C, the model is a 2-dimensional billboard model. The model can therefore be assumed to lie in the plane of the wall 355. The distance from the instrument to the wall 355 can be determined by taking a reading from the laser rangefinder and the scale associated with the model can therefore be determined.

The real world dimensions of the model 353 may be adjusted manually by a user. For example, a user may drag the corners of the model 353 to resize the model as shown in FIG. 35D. In this drawing, the model has been resized to 1.71 by 0.85 metres and is a better fit to the available space. In practice, the user may manually resize the model until it has the desired visual appearance and then read the required dimensions from the screen, or press a button to capture the required dimensions. In some embodiments an image of the building with the overlaid model may be captured, and later changes to the model size may be made at a later time.

In variations of this embodiment the instrument may make an initial fit of the model to the available space, for example by automatically detecting edges defined by rooflines, wall edges and windows, and resizing the model to allow a predefined standard spacing between the model and the detected edges. This initial fit may then be adjusted by the user.

Further, the position of the site in which the billboard or other object will be installed may be simultaneously captured, together with the image of the site and the required dimensions of the billboard or other object. The position may be determined by any of the methods described above, or disclosed in the Applicant's U.S. Pat. No. 7,647,197 or PCT/NZ2011/000257.

The determined dimensions 356 of the model may then be used in fabrication of the required billboard or other object. The dimensions may be taken manually from the instrument or may be sent automatically from the instrument to a fabrication system.

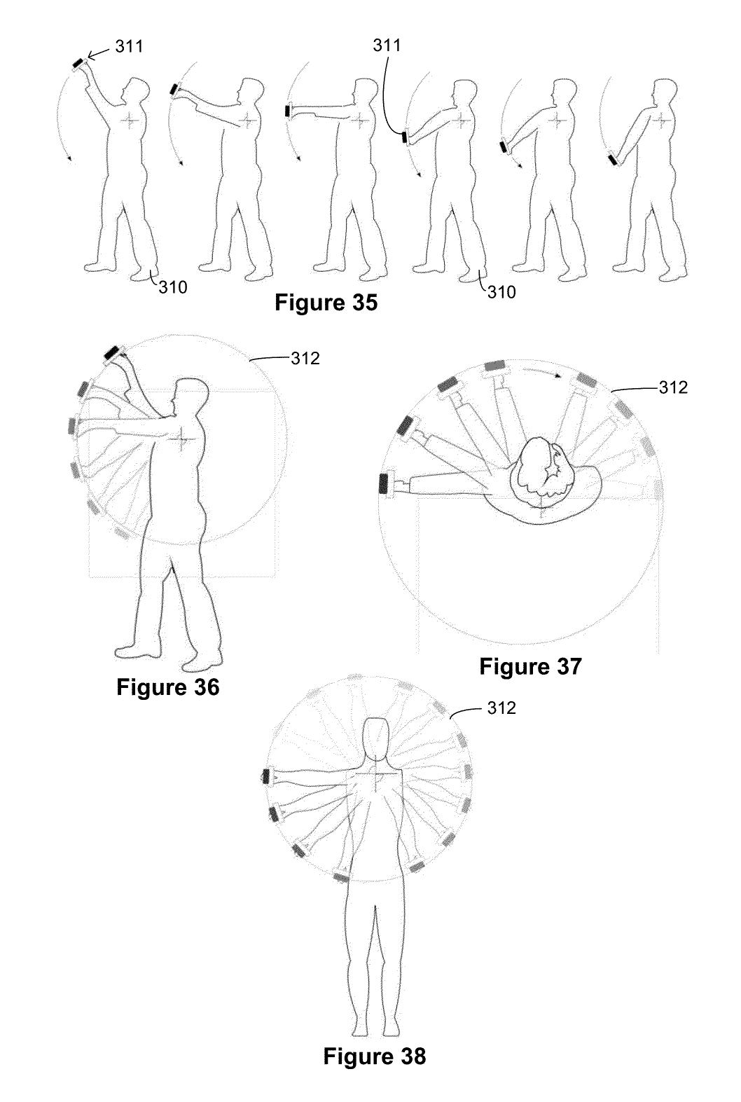

FIGS. 36A-D show an embodiment in which a model 360 of an existing real object with known dimensions can be overlaid on the instrument display 351. The model may be any suitable 2- or 3-dimensional model and may be generated by a designer or may be captured by photographing and/or measuring a physical image or object, or may be obtained or generated in any other suitable manner. Where a physical object is photographed using the Applicant's instrument, its dimensions may simultaneously be captured using the instruments spatial sensors, as described above.

FIG. 36A shows the model 360 displayed on display 351. The model dimensions 361 may be displayed. However, in this embodiment the model corresponds to a fixed real world object, so no user adjustment of dimensions is allowed.

FIG. 36B shows the model 360 overlaid on an image obtained from the instrument's camera. The model is properly scaled such that its dimensions correspond to the dimensions of the scene in the captured image. Again, this can be achieved by capturing data using the instrument's spatial sensors, particularly the laser rangefinder. This can also be combined with the continuous or periodic capture methods described above, to allow the scale of the model 360 to be updated as necessary when the user moves the device.

The model 360 may be fixed to the centre of the frame, with the image moving as the user moves the instrument. Alternatively, the user may be permitted to move the model within the frame, for example by dragging the model.

In preferred embodiments the rotational alignment of the model 360 may be adjusted, as indicated in FIG. 36C. The user may swipe the model as indicated by arrows 362 to rotate it about a vertical axis. Rotation about other axes may also be allowed. However, where the model has a flat base and is to rest on a horizontal surface, rotation may be limited to the vertical axis.

FIG. 36D shows how a user can move the model to obtain an impression of how the object will look in a particular position. This drawing shows the model 360 positioned in a corner. The user can move the instrument and/or the model to determine how the object will look in various positions and/or orientations, assisting the user to determine where the object should ultimately be placed. Images showing the model overlaid on the scene can be captured for later review if desired.

The instrument 1 is handheld and portable. It can therefore be conveniently carried and used.

Computer instructions for instructing the above methods may be stored on any suitable computer-readable medium, including hard-drives, flash memory, optical memory devices, compact discs or any other suitable medium.

While the invention has been described with reference to GPS technology, the term GPS should be interpreted to encompass any similar satellite positioning system.

The skilled reader will understand that the above embodiments may be combined where compatible.

While the present invention has been illustrated by the description of the embodiments thereof, and while the embodiments have been described in detail, it is not the intention of the Applicant to restrict or in any way limit the scope of the appended claims to such detail. Further, the above embodiments may be implemented individually, or may be combined where compatible. Additional advantages and modifications, including combinations of the above embodiments, will readily appear to those skilled in the art. Therefore, the invention in its broader aspects is not limited to the specific details, representative apparatus and methods, and illustrative examples shown and described. Accordingly, departures may be made from such details without departure from the spirit or scope of the Applicant's general inventive concept.

1. A mobile handheld instrument including:
i. a camera configured to capture an image;
ii. a display configured to display the image;
iii. a processor configured to determine an orientation of a surface within the image;
iv. a user interface configured to receive a user selection of a region on the surface;
wherein the user selection of the region is forced into alignment with the determined orientation of the surface.

2. A mobile handheld instrument as claimed in claim 1 wherein the display is configured to display the selected region overlaid on the image.

3. A mobile handheld instrument as claimed in claim 1 wherein the region is a one dimensional region.

4. A mobile handheld instrument as claimed in claim 3 wherein the user selection of the region is forced into alignment with a true space horizontal or true space vertical based on the determined orientation of the surface.

5. A mobile handheld instrument as claimed in claim 1 wherein the region is a two dimensional region.

6. A mobile handheld instrument as claimed in claim 5 wherein the user selection of the region is forced into alignment with a true space horizontal and a true space vertical based on the determined orientation of the surface.

7. A mobile handheld instrument as claimed in claim 5 wherein the region is a true space rectangle.

8. A mobile handheld instrument as claimed in claim 7 wherein the user selection of the region consists of the user selecting a first corner of the rectangle and a second diagonally opposite corner of the rectangle.

9. A mobile handheld instrument as claimed in claim 8 wherein selecting the first and second corners consists of the user dragging a pointer from the first corner to the second corner.

10. (canceled)

11. (canceled)

12. A mobile handheld instrument as claimed in claim 1 wherein determining the orientation of the surface includes identifying one or more sets of parallel lines in the image and analyzing the vanishing point of each set of parallel lines.

13. A mobile handheld instrument as claimed in claim 1 wherein determining the orientation of the surface includes identifying the positions of three or more points on the surface and fitting a surface to those points.

14. A mobile handheld instrument as claimed in claim 1 wherein determining the orientation of the surface includes identifying one or more shapes on the surface and determining an orientation of the surface based on knowledge or assumptions relating to the true space properties of those shapes.

15. A mobile handheld instrument as claimed in claim 1 configured to receive a user copy instruction and to create a copy of the user selection in response to the user copy instruction and to display the copy of the user selection on the display.

16. A mobile handheld instrument as claimed in claim 15 configured to receive a user instruction to move the copy of the user selection, to move the displayed copy of the user selection, wherein the true space dimensions of the copy of the user selection are retained during movement of the copy of the user selection, with the displayed dimensions of the copy of the user selection being adjusted accordingly during movement of the copy of the user selection.

17. A mobile handheld instrument as claimed in claim 15 configured to detect like image regions based on comparison of image data within the user selection with image data elsewhere on the surface and to replicate the user selection at each like image region.

18. A mobile handheld instrument as claimed in claim 17 wherein each replica user selection has the same true space dimensions and orientation as the user selection.

19. (canceled)

20. A mobile handheld instrument as claimed in claim 1 configured to receive a user instruction to adjust the determined orientation of the surface or the forced alignment of the user selection and to adjust the determined orientation or forced alignment accordingly.

21. A mobile handheld instrument as claimed in claim 1 configured to determine one or more true space measurements and to display those measurements.

22. (canceled)

23. A mobile handheld instrument as claimed in claim 1 further including a rangefinder.

24. A mobile handheld instrument as claimed in claim 1 further including a positioning sensor.

25. A mobile handheld instrument as claimed in claim 1 further including one or more orientation sensors.

26. A method of data collection in a mobile handheld instrument including:
i. a camera;
ii. a display;
iii. a processor; and
iv. a user interface
the method including the steps of:
a) receiving a capture instruction from a user;
b) in response to the capture instruction, capturing an image using the camera;
c) displaying the captured image on the display;
d) the processor determining an orientation of a surface within the image;
e) the user interface receiving a user selection of a region on the surface;
f) forcing the user selection of the region into alignment with the determined orientation of the surface; and
g) displaying the user selection on the display.

27. A method as claimed in claim 26 wherein the region is a one dimensional region.

28. A method as claimed in claim 27 wherein the step of forcing the user selection of the region into alignment with the determined orientation of the surface comprises forcing the user selection into alignment with a true space horizontal or true space vertical based on the determined orientation of the surface.

29. A method as claimed in claim 26 wherein the region is a two dimensional region.

30. A method as claimed in claim 29 wherein the step of forcing the user selection of the region into alignment with the determined orientation of the surface comprises forcing the user selection into alignment with a true space horizontal and a true space vertical based on the determined orientation of the surface.

31. A method as claimed in claim 29 wherein the region is a true space rectangle.

32. A method as claimed in claim 31 wherein the step of receiving a user selection of a region on the surface consists of receiving a user identification of a first corner of the rectangle and a second diagonally opposite corner of the rectangle.

33. A method as claimed in claim 32 wherein the step of receiving a user selection of a region on the surface consists of receiving a user identification of a first corner of the rectangle and a second diagonally opposite corner of the rectangle by dragging a pointer from the first corner to the second corner.

34. (canceled)

35. (canceled)

36. A method as claimed in claim 26 wherein determining the orientation of the surface includes identifying one or more sets of parallel lines in the image and analyzing the vanishing point of the each set of parallel lines.

37. A method as claimed in claim 26 wherein determining the orientation of the surface includes identifying the positions of three or more points on the surface and fitting a surface to those points.

38. A method as claimed in claim 26 wherein determining the orientation of the surface includes identifying one or more shapes on the surface and determining an orientation of the surface based on knowledge or assumptions relating to the true space properties of those shapes.

39. A method as claimed in claim 26 further including:
receiving a user copy instruction,
creating a copy of the user selection in response to the user copy instruction, and
displaying the copy of the user selection on the display.

40. A method as claimed in claim 39 further including:
receiving a user instruction to move the copy of the user selection,
moving the displayed copy of the user selection while retaining the true space dimensions of the copy of the user selection during movement of the copy of the user selection and adjusting the displayed dimensions of the copy of the user selection accordingly.

41. A method as claimed in claim 39 further including:
detecting like image regions based on comparison of image data within the user selection with image data elsewhere on the surface, and
replicating the user selection at each like image region.

42. A method as claimed in claim 41 wherein each replica user selection has the same true space dimensions and orientation as the user selection.

43. (canceled)

44. A method as claimed in claim 26 further including:
receiving a user instruction to adjust the determined orientation of the surface or the forced alignment of the user selection, and
adjusting the determined orientation or forced alignment accordingly.

45. A method as claimed in claim 26 further including:
determining one or more true space measurements, and
displaying those measurements.

46. (canceled)

47. A method as claimed in claim 26 wherein
the instrument further includes a rangefinder, the method further including:
receiving a user capture instruction, and
capturing an image from the camera and a distance measurement from the rangefinder in response to that user capture instruction.

48. A method as claimed in claim 26 wherein the instrument further includes a rangefinder, a positioning sensor and one or more orientation sensors, the method further including:
receiving a user capture instruction, and
capturing an image from the camera, a distance measurement from the rangefinder, a position from the positioning sensor and an orientation from the one or more orientation sensors, in response to that user capture instruction.

49.-98. (canceled)

99. A method of data collection in a mobile handheld instrument including:
i. a camera;
ii. a display; and
iii. a processor;
the method including the steps of:
displaying an image captured by the camera on the display;
the processor determining an orientation of a surface within the image;
overlaying a graphic of a virtual or real object on the displayed image; and
forcing the displayed graphic into alignment with the determined orientation of the surface.

100. A method as claimed in claim 99, further including storing an image including the captured image and the overlaid, aligned graphic in response to a user capture instruction.

101. A method as claimed in claim 99 the processor determining a scale associated with a region within the image, the graphic being overlaid on that region, the object having associated dimensions, wherein the dimensions of the overlaid graphic correspond to the dimensions associated with the object and the scale associated with the region.

102. A method of data collection in a mobile handheld instrument further including the steps of:
e) the processor determining a scale associated with a region within the image;
f) overlaying a graphic representing a virtual or real object on the region of the displayed image, the object having associated dimensions, wherein the dimensions of the overlaid graphic correspond to the dimensions associated with the object and the scale associated with the region.

103. A method as claimed in claim 102, wherein the graphic represents a virtual object and the method further includes a user adjusting the dimensions of the overlaid graphic, and the processor determining adjusted dimensions associated with the object based on the dimensions of the overlaid graphic and the scale associated with the region.

104. A method of manufacturing an object, including: determining dimensions associated with the object by the method of claim 103 and manufacturing the object according to those dimensions.
